(19) United States
(12) Patent Application Publication
(10) Pub. No.: US 2004/0091171 A1
(43) Pub. Date: May 13, 2004

(54) Mosaic construction from a video sequence

(76) Inventor: Donald James Bone, Kaleen (AU)

Correspondence Address: KOLISCH HARTWELL, P.C., 520 S.W. YAMHILL STREET, SUITE 200, PORTLAND, OR, 97204, US

(21) Appl. No.: 10/618,496

(22) Filed: Jul. 11, 2003

(30) Foreign Application Priority Data
Nov. 7, 2002 (AU) 2002950210

(51) Int. Cl. G06K 9/36; G06K 9/00; G06K 9/46; G06K 9/32

(52) U.S. Cl. 382/284; 382/103; 382/294; 382/233

(57) ABSTRACT

Techniques for constructing a mosaic image from an MPEG video sequence. Constructing a mosaic image involves aligning and compositing the pictures of an MPEG compressed video. The described techniques use motion vectors in the MPEG video sequence directly to achieve picture-to-picture registration for each picture for which the MPEG video contains motion information.

### TECHNICAL FIELD

The invention relates generally to constructing mosaic images from a video sequence.

### BACKGROUND

Taking several overlapping pictures of an extended scene so that the resulting pictures are used to form a larger image that can be a captured with a single picture is almost as old as photography. Such “panoramas” can be assembled from a number of printed photographs overlapped and suitably trimmed. The advent of digital image manipulation has resulted in a recent resurgence of interest in the joining of pictures to effect a larger image.

When a video camera is panned across a scene, the video camera captures a series of pictures in video format, which are well suited to the formation of panoramic images. The limited resolution of most video camera means that there is even more reason to consider generating panoramic images for video camera images, as still cameras (in comparison with video cameras) usually have higher resolution and a range of lenses that makes wide angle photography more feasible. A panoramic capability then offers a video camera the capacity to take images having a wider field of view and higher spatial resolution than video cameras can achieve without this capability.

An understanding of how such existing panoramic techniques are applied requires an understanding of current analogue and digital video formats. The usual model for analogue video follows the conventions of film-based moving pictures, which involves a series of still pictures. Digital video formats maintain this model, but often differ considerably in structure from analogue video. The movement away from the intuitive structure of a series of directly coded independent pictures has been motivated by the huge amounts of information associated with video. Most digital video standards seek to take advantage of spatial and temporal redundancy in the sequence of pictures to achieve significant data compression.

As pictures in a video sequence are often very similar, there is redundancy in the form of information that is repeated with very little change from one picture to the next in a sequence of pictures. Much of the change in the content of the pictures in a video sequence is in simple geometric motion of the contents of the scene from picture-to-picture. As the image is actually a projection of the outside world onto the focal plane of the camera, simple translation of the whole picture between pictures often does not predict neighbouring pictures sufficiently well. The change in geometry produced by the projection process is more complex than simple translation. These more complex changes in geometry can often be approximated by a simple translation of small blocks of pixels within the picture.

This block-based motion compensated prediction effectively predicts a block from a similar nearby region of an earlier or later picture and allows for further compression of the data through the reduction in temporal redundancy. The resulting set of “motion vectors”, one for each block in a picture, also (approximately) characterizes the complex motion of the contents of the scene from one picture to the next. The difference between a block and the motion-compensated! prediction of the block from earlier or later pictures is stored as a residual image.

The process of reducing spatial redundancy usually involves dividing each picture of a video sequence into small square blocks of pixels and encoding them with some form of mathematical transform. A quantization step is then used which reduces the number of different values for the transform coefficients and tends to set the less important components in the transform to zero. This quantization process, particularly when the process results in a large proportion of the transform coefficients being zero, facilitates an efficient compression of the image data. Removal of spatial redundancy using this process results in a significant compression of the information required to represent each picture. Some pictures in a video sequence (such as the I-pictures in an MPEG-coded sequence), are coded only with a spatial coding such as described above. Other pictures (such as the P- and B-pictures) are approximated using block-based motion compensated prediction, and the residual information is then coded with spatial coding such as that described herein.

Among the most efficient forms of compression available for coding digital video are standards produced by the Motion Pictures Experts Group (MPEG). Their efficiency, however, is at the cost of complexity in their internal working. This complexity makes manipulation of the video, in compressed form, difficult.

Two MPEG standards are colloquially known as MPEG-1 and MPEG-2. These lossy video digital compression standards are described in detail in the International Standards Organisation documents, which for MPEG-1 are numbered ISO/IEC 11172-1 (1993) to ISO/IEC 11172-5 (1998) and for MPEG-2 are numbered ISO/IEC 13818-1 (1995) to ISO/IEC 13818-10 (1999). The parts of these respective standards dealing with video coding are ISO/IEC 11172-2 (1993) entitled “Information Technology—Coding of Moving Pictures and Associated Audio for Digital Storage Media at up to about 1.5 Mbit/s: Part 2—Video”, and ISO/IEC 13818-2 (1995) entitled “Information Technology—Generic Coding of Moving Pictures and Associated Audio Information—Part 1 Systems: Part 2—Video”.

The following description relates to video digital compression standards, which for simplicity are collectively referred to as MPEG, except where differentiation between the two standards is necessary. Much of what is described also relates to the new standard known as MPEG-4.

Due to the complexity of the MPEG format, manipulation of an MPEG video without first decoding the MPEG video to a sequence of independently coded pictures is difficult. A disadvantage of this decoding requirement is that decoding produces a huge increase in the volume of data that must be processed.

Current methods of generating panoramic images or mosaics from an MPEG video sequence usually involve a first step of analysing pairs of images to determine correspondences between features in the images. This motion analysis step can be computationally expensive, and requires each picture to be fully decoded to perform the analysis.

Once correspondences are identified, various methods can be used to generate a model of geometric transformations from one picture to the other that produce the best registration of the two pictures. Once the transforms are known between a sufficiently large subset of all of the possible pairs of spatially overlapping pictures, concatenation of these transforms allows the construction of a suitable transform between any pair of pictures, or indeed between any picture and a single reference picture.

A particular disadvantage of the existing methods of generating mosaics that rely on motion analysis to register the pictures in a sequence is that motion analysis is computationally expensive, and often requires manual intervention. Consequently, such existing techniques often use only a small fraction of the pictures available to construct a mosaic, so that the mosaic can be constructed in a reasonable time. A further disadvantage of these existing methods is that access is required to the decoded form of all of the pictures used in the mosaic for the purposes of the motion analysis, which can require large amounts of memory.

In view of the above observations, a need clearly exists for improved techniques for constructing mosaic images from video sequences.

### SUMMARY

The described techniques relate to constructing a mosaic image from an MPEG video sequence. Constructing a mosaic image involves aligning and compositing the pictures of an MPEG compressed video. The described techniques use motion vectors in the MPEG video sequence directly to achieve picture-to-picture registration for each picture for which the MPEG video contains motion information.

Several sub-systems take these raw motion models and integrate the information from these models to automatically break the video sequence into motion-connected subsequences and build models for each picture, which reference a single common reference picture for each subsequence.

Further sub-systems then allow refinement of the models to reduce registration errors and to optimally match the intensity of pictures where they overlap. A final sub-system uses the registration information and the intensity models and assembles the mosaic image using one of a number of compositing rules.

The following numbered paragraphs summarize the procedure involved in producing a mosaic image using the techniques described herein.

1. Initial motion models are produced for each of a set of picture pairs (consisting of a first and a second picture) based entirely on embedded motion vector information. Image information in either encoded or decoded form is not accessed.

2. A robust fitting technique is used to remove outlier motion vectors. This robust fitting technique applies the same motion model to determine the outliers as the model being fitted to the motion.

3. A consistent subset of macro-blocks is identified within each modelled first picture. Each such subset has a motion vector consistent with the constructed motion model and, by inference, likely to contain background image information with edge-like features and uncontaminated by independent object motion. Again, there is no need to use the image data in either encoded or decoded form.

4. A series of model concatenation processes are used to produce the backward and forward picture-pair motion models. These processes can be used to construct (from the picture-to-picture models) an inferred reference model for each picture, such that:

(i) all of the reference models in any subsequence refer to the same reference coordinate system; and

(ii) any picture contiguous with a subsequence can be linked to a picture in that subsequence by a series of motion models is in that subsequence.

5. A model refinement process for refining selected picture-to-picture motion models or generating new picture-to-picture motion models is used. This process needs only to decode image information for certain macro-blocks chosen selected using the consistent subset of macro-blocks referred to above.

6. A global registration process that minimises a global measure of the inconsistency associated with registration of the pictures is performed. This global measure is sensitive to the resolution of the various images so that higher resolution images achieve better registration than lower resolution pictures.

7. A picture intensity correction process that determines a set of intensity correction models, which match overlapping pictures in a globally consistent manner.

8. A flood compositing process that uses a pixel-to-pixel flooding operation (requiring no image information) to decide which picture(s) in the sequence will contribute to each pixel in the mosaic. A secondary flood process then constructs the mosaic image, accessing the sequence images in stored order.

9. Alternatively, a sequential compositing process accesses image information in stored order, and uses the motion models to register the pictures and accumulate information from the pictures in a set of accumulators. These accumulators can later be used to construct the mosaic image.

The following numbered advantages are associated with use of the described techniques.

1. The initial motion models are constructed without the need for computationally-expensive feature identification and matching, and without the need to decode any of the image data.

2. The described concatenation process minimizes the number of motion-connected subsequences that result. Earlier techniques for concatenating the picture-to-picture motion models often result in breaking the sequence into a larger number of disconnected subsequences than is necessary.

3. If more accurate picture-to-picture models are required than can be obtained from the motion vectors alone, then the described model refinement process can refine the model using image data from only a small number of macroblocks. These macroblocks can be identified using the subset of consistent macroblocks, thus reducing both computational and memory requirements. The models can be efficiently refined, using as a starting point the already obtained picture pair model, or an inferred picture pair model constructed from reference models associated with the pictures in the picture pair. Consequently, the time required for the model refinement process is reduced compared to producing a model from the picture data alone.

4. The described global registration process uses a measure of the inconsistency that relates to the misregistration in the captured pictures. This ensures that more highly zoomed images demand a higher registration accuracy than less zoomed pictures. Existing techniques rely on a measure that relates to misregistration in the reference coordinate system. Accordingly, zoomed images tend to suffer similar misregistration to other images, in spite of their higher resolution.

5. The described intensity correction process produces a globally optimal solution rather than an ad hoc solution, as is the case with existing methods. This results in more consistent and higher-quality intensity correction.

6. If the flood compositing process is used, then only those macroblocks of the images in the sequence that are required to calculate the values of pixels that contribute to the mosaic need to be decoded. This reduces computational costs.

7. The flood process, which generates the image in the flood compositing, is organised so that the pictures are accessed in the same order in which they appear in the compressed file. Disk access and the amount of image data that must be stored in memory is thus minimised.

8. If the sequential compositor is used, the mosaic construction process only needs to fully decode the images in the sequence as the last step of the process and is able to decode the pictures in the same sequence in which these pictures appear in the compressed file. This reduces disk access and memory requirements compared to existing methods.

### DESCRIPTION OF DRAWINGS

FIG. 1 is a flowchart that represents steps involved in the functioning of the total system, providing an overall summary of the functioning of the system at a major component level.

FIG. 2 is an object oriented class diagram that represents relationships between the major software components in the described system.

FIG. 3 is a flowchart representing steps involved in the functioning of the robust fitting sub-system responsible for using the MPEG motion vectors to estimate motion models for pictures in the sequence.

FIG. 4 is a flowchart representing steps involved in the functioning of the model concatenation sub-system responsible for concatenating the raw picture-to-picture motion models to estimate motion models relative to a chosen reference picture.

FIG. 5 is a flowchart involved in the concatenation process illustrated as a sequence of operations applied to a typical set of MPEG pictures.

FIG. 6 is a flowchart representing steps involved in the functioning of the subsequence partitioning sub-system responsible for dividing the concatenated sequence into motion connected subsequences.

FIG. 7 is a flowchart representing steps involved in the functioning of the model refinement sub-system, which uses the estimated motion model for a chosen pair of pictures as a starting point for a process that optimises the motion model parameters' to give a best mapping between the chosen pictures.

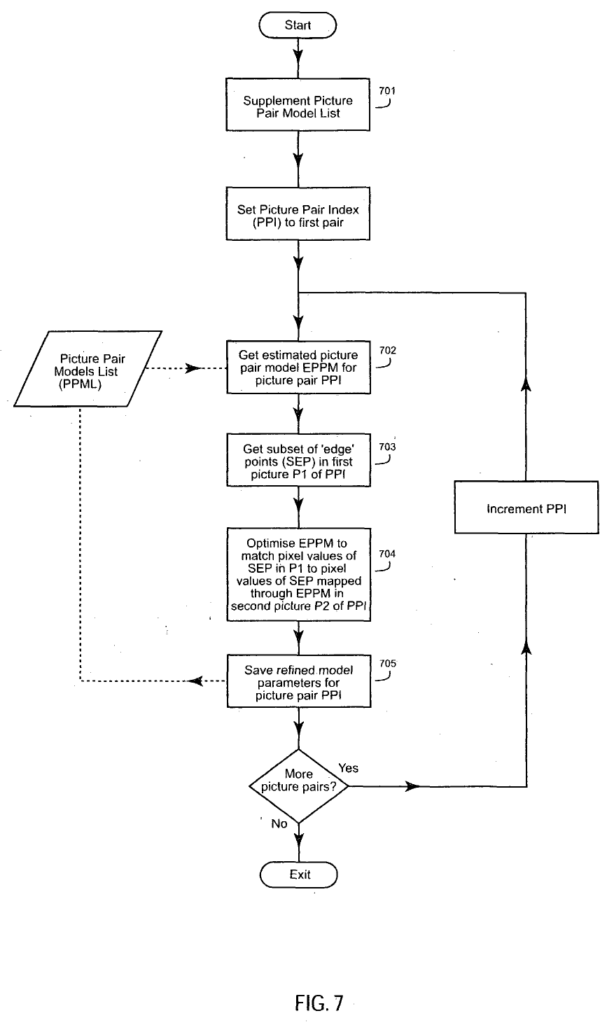

FIG. 8 is a flowchart representing steps involved in the functioning of the Model List Supplementation Sub-system, which selects pictures that have an overlap in a defined range which make them appropriate for constructing a motion model, but for which the original video has no direct motion information.

FIG. 9 is a flowchart representing steps involved in the functioning of the Global Registration Sub-system. This sub-system adjusts the motion models to achieve a globally optimum consistent set to reduce the effects of misregistration due to accumulated error.

FIG. 10 is a schematic representation of potential picture-to-picture motion models from nearest neighbour pictures, arranged in a zigzag pan.

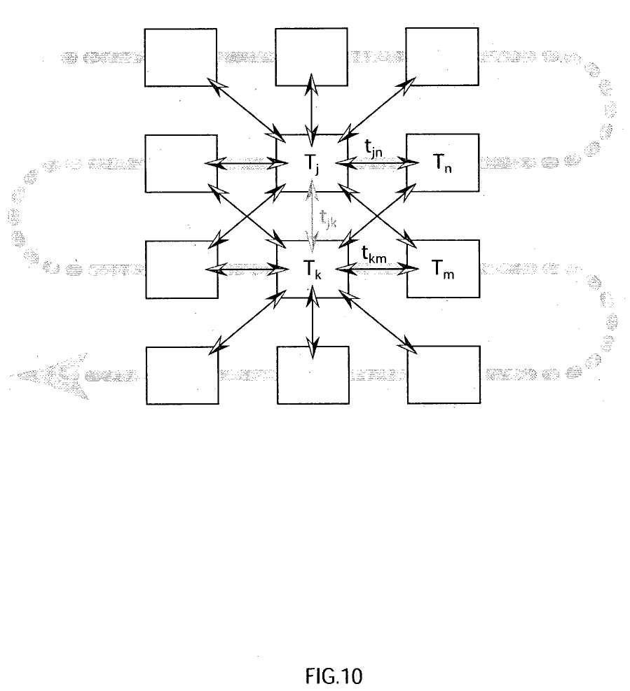

FIG. 11 is a flowchart representing steps involved in the functioning of the Global Intensity Correction Sub-system, which is responsible for creating intensity correction models to compensate for variation in environmental lighting conditions and the effects of automatic gain control.

FIG. 12 is a flowchart representing steps involved in the functioning of the compositing system, which takes the motion models, the intensity correction models and the video pictures and uses one of a number of possible methods to combine the pictures to form a mosaic image.

FIG. 13 is a flowchart representing steps involved in the operation of the flood compositing sub-system.

FIG. 14 is a flowchart representing steps involved in creating a mosiac image using the flood compositing sub-system.

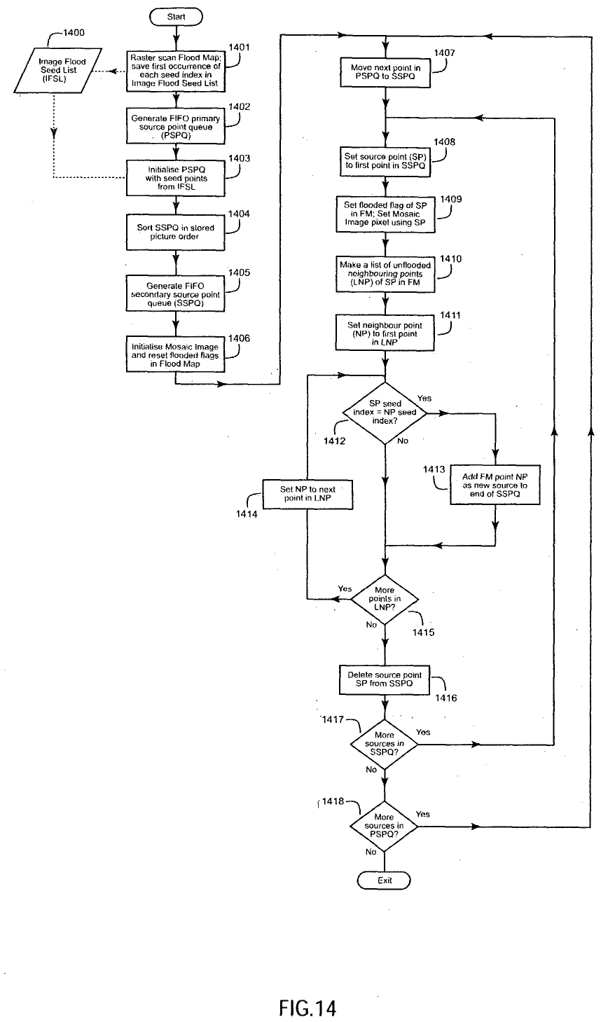

FIG. 15 is a flowchart representing steps involved in the operation of the sequential compositing sub-system.

FIG. 16 is a schematic representation of a pure translation motion model that may be used in registering overlapping pictures.

FIG. 17 is a schematic representation of a rotation-translation-zoom (RTZ) motion model that may be used in registering overlapping pictures.

FIG. 18 is a schematic representation of an affine motion model that may be used in registering overlapping pictures.

FIG. 19 is a schematic representation of a projective transform motion model that may be used in registering overlapping pictures.

FIG. 20 is a schematic representation of a computer system of a type that may be sued to perform the techniques described herein with reference with reference to FIGS. 1 to 19.

### DETAILED DESCRIPTION

The techniques described herein are described with reference to the accompanying figures, many of which are flowcharts that represent procedures involved in producing a mosaic images from component images of a video sequence, such as MPEG-encoded digital video data.

Overview

The described techniques include a system for creating mosaic images from a video coded with a block-based, motion prediction video encoding scheme such as MPEG-1 or MPEG-2. There are a number of sequential operations applied to the coded video that result in the construction of a seamless mosaic image. By using the video in an encoded form, and only decoding the images sequentially as they are required, the memory requirements required for generating a mosaic image are reduced.

Scalable functionality is provided. Relatively quick (but less accurate) mosaic image can be provided with registration based solely on encoded motion vectors. In more sophisticated mosaics, the registration models are refined using image data and the global re-distribution of registration inconsistencies. Any intensity variation between aligned pictures is corrected in a globally optimum manner.

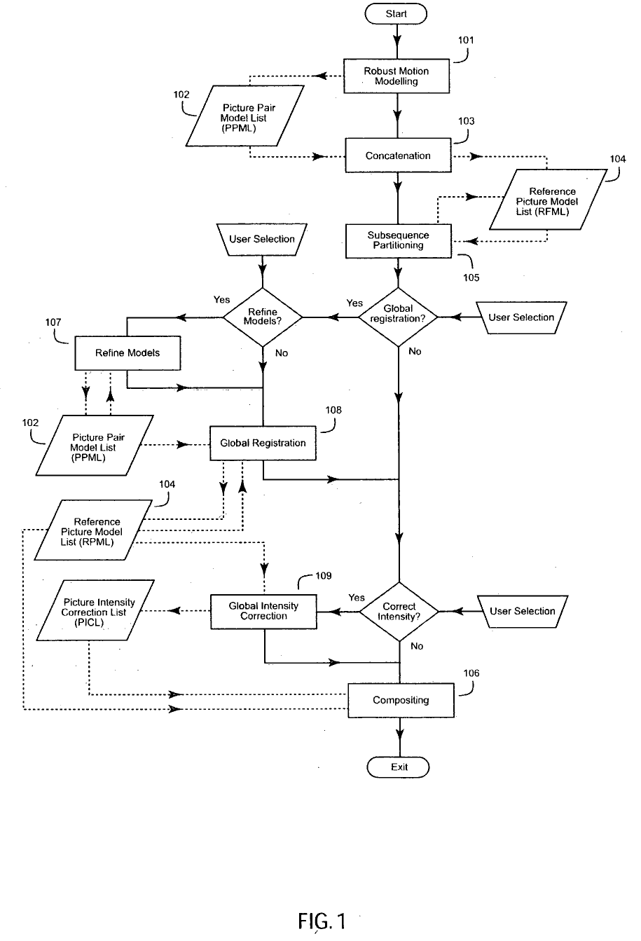

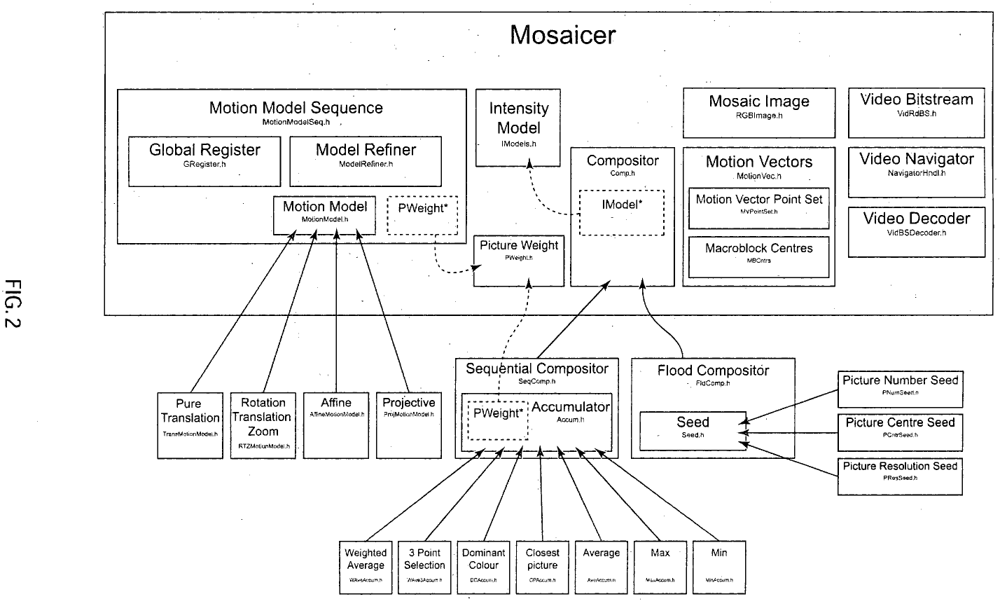

The major components of the described mosaicing system and the operation of the system is summarised in FIG. 1, while the class hierarchy for the object oriented implementation of the system is illustrated in FIG. 2.

The described system takes an MPEG video and sequentially accesses the coded motion vector information for each picture in the portion of the sequence to be mosaiced. For each P-picture there are forward motion vectors for a subset of the macroblocks in the picture. These motion vectors provide the offset to the nearest matching block of pixels in the forward prediction reference picture (the most recent P- or I-picture before this picture). For each B-Picture there are both forward or backward motion vectors for a subset of the macroblocks in the picture.

The forward motion vectors in a B-picture are treated in the same way as the forward motion vectors in a P-picture. The backward motion vectors provide the offset to the nearest matching block of pixels in the backward prediction reference picture (the next P- or I-picture after the current picture). For both the forward and the backward motion-vector set, the system uses the operations of the Robust Motion Modelling Sub-system (step 101) to determine the parameter values for a picture-to-picture motion model that represents a best fit to a predetermined percentage of the motion vectors. The parameters for the model for each picture are saved in a Picture Pair Model List (PPML) (step 102), which captures a set of geometric transformations between each picture and its respective forward and/or backward reference picture.

To create a mosaic, overlapping pictures from the sequence must all be registered relative to the coordinate system of a chosen picture, or to a coordinate system whose geometry relative to the coordinate system of a chosen picture is known. The set of picture-to-picture motion models must be converted to a set of models all referencing the same picture (or a reference coordinate system with a known transform to a chosen picture). To perform this conversion, the sequence of picture-to-picture models, which lead from each picture in the sequence to the chosen reference coordinate system, must be combined.

MPEG video does not guarantee that a given sequence is wholly motion connected in this way, so this conversion may not always be possible. A series of model concatenation operations are used in the “Model Concatenation Sub-system” (step 103) that for most sequences makes close to optimum use of the available backward and forward models to estimate the set of reference motion models. These models are placed in the “Reference Picture Model List” (RPML) (step 104). The system then also determines the start and end pictures of all motion-connected subsequences in the Subsequence Partitioning Subsystem (step 105).

If the user requires only an approximate mosaic then the system allows them to proceed to composite the images in a motion connected subsequence, or a subset of them, into a single mosaic image using one of a number of compositing rules (step 106). If, however, the user wants to improve the registration of the images there are two sub-systems provided to help achieve this objective. The first sub-system is the “Model Refinement Sub-system” (step 107). This sub-system allows the user to select picture pairs for which the system can use the picture image data to produce a refined motion model. These selected picture pairs may be picture pairs for which the MPEG video contains no motion vector information. This is most important when the panning pattern results in significant overlap in pictures that are well separated in the video sequence.

The second sub-system available for improving the registration of the pictures is the “Global Registration Sub-system” (step 108). This sub-system can be used instead of, or in addition to, the “Model Refinement Sub-system” (step 107) to redistribute the errors in the registration in such a way as to globally minimise inconsistencies in the motion models. This objective is achieved by adjusting the models that transform the coordinate in each picture to the equivalent coordinates in the common reference picture (the Reference Picture Models). These modified models are written back over the original models in the “Reference Picture Model List” (step 104). Changes to the Reference Picture Models seek to minimise a measure of the total difference between the picture-to-picture models (from the Robust Fitting Sub-system or from the Model Refinement Sub-system) and estimates of the picture-to-picture models based on the Reference Models Picture Models.

In some sequences, the environmental lighting can vary during the capture of the sequence or the video camera's Automatic Gain Control function may make adjustments to keep the average exposure of the scene constant. Such effects can result in the exposure of some parts of the scene varying from picture-to-picture as the scene is panned. The “Global Intensity Correction Sub-system” (step 109) allows a user to automatically create, for each picture, intensity correction models that globally optimise the match of those portions of the pictures in the sequence that overlap other pictures in the sequence.

Once the user is satisfied with the registration and intensity correction, the user can use one of a number of available compositing methods (step 106) to combine the registered pictures from the sequence to form a mosaic image.

Robust Motion Modeling from Encoded Motion Vectors

The motion Vector information in MPEG compressed video (and in some other forms of compressed video) already contains information which would allow the construction of the necessary geometric transformations to register the pictures in a sequence. Unfortunately, many of the motion vectors are unreliable and some form of robust filtering or fitting procedure is required which can discriminate between the good motion information and the spurious outliers.

The described techniques employ a robust fitting technique to construct a set of models of the differential motion between each picture in the sequence and its reference picture. This technique is related to a statistical technique called “Least Median of Squares Regression” (LMSR) developed by P. J. Rousseeuw, Journal of American Statistical Association, volume 79, pages 871 to 880, 1984. The content of this reference is incorporated herein by reference. This technique is implemented with the difference that absolute error is used in preference to squared error. Also, a variable percentile error measure is used in preference to a fixed median error measure. The statistical community views LMSR as being unsound when the proportion of good data points is less than the number of spurious points. With the modifications described directly above, however, empirical observations indicate that useful results can be obtained when the proportion of good data points is as low as 25%.

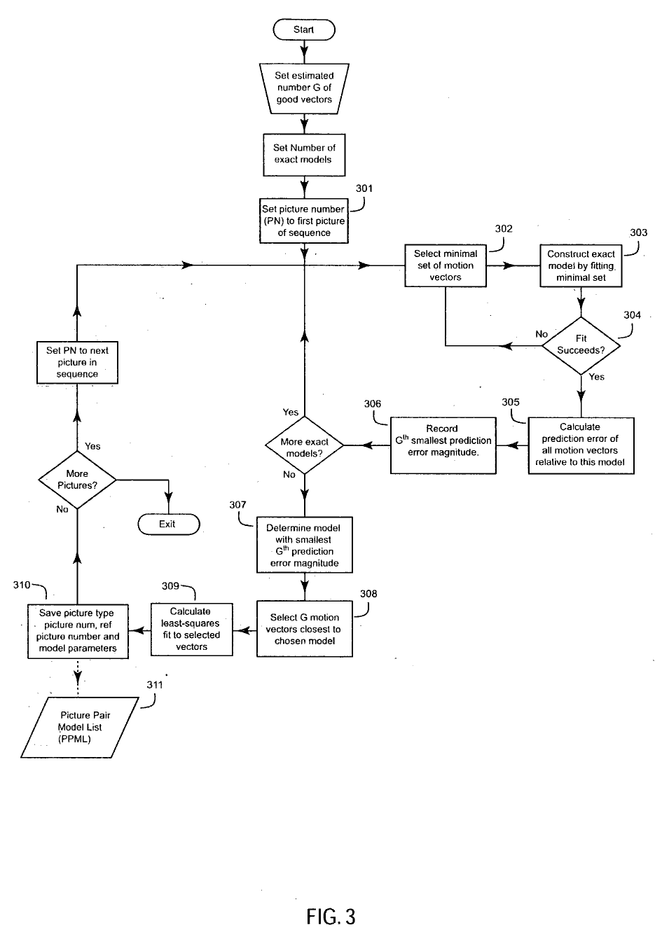

FIG. 3 flowcharts the operation of the Robust Motion Modelling Sub-system.

Setting the Number of Exact Models

The modeling process requires the generation of a number of exact models, each created by fitting the chosen model to a minimal sub-set of the motion vectors from a given picture. The minimal sub-sets of vectors must all be distinct from each other, so that each fitted model is unique. Further, the minimal sub-sets must be such that the sub-sets each provide only enough points to exactly fit the parameters of the chosen model.

Enough of these unique models are generated so that the probability of not producing any models that rely on only good motion vectors is reduced to an acceptable threshold. To calculate how many models must be generated to ensure this threshold is reached, a presumption is made that the set of S motion vectors from a given picture consists of G “good” motion vectors and (S-G) “bad” motion vectors.

The selection is performed in such a way as to ensure that motion vectors are chosen only once in each set. This objective is achieved by effectively choosing a number between 1 and S for the index of the first motion vector, then an index between 1 and S-1 for the index to the second motion vector, and so on until the n motion vectors are chosen. These indices are used to select the motion vectors from the set of motion vectors remaining from the original set of S motion vectors at each stage after the already chosen subset of motion vectors are eliminated.

The number of unique subsets of n different motion vectors from any set of S motion vectors is as expressed in Equation (1) below.

$${N}_{mx} = \frac{( S ) !}{( S - n ) ! n !} \qquad ( 1 )$$

The number of uncontaminated subsets with no bad motion vectors is as expressed in Equation (2) below.

$${N}_{AG} = \frac{( G ) !}{( G - n ) ! n !} \qquad ( 2 )$$

To guarantee that at least one of the “all good” subsets is selected, a certain minimum number (Nₘₙ) of selections is required, as expressed in Equation (3) below.

Nₘₙ=Nₘₓ−N_{AG}+1 (3)

This minimum number (Nₘₙ) of required is, however, usually much more than required. The probability of a set chosen randomly from all possible sets containing only good motion vectors is as expressed in Equation (4) below.

$${P}_{AG} = \frac{G ! ( S - n ) !}{( G - n ) ! S !} \qquad ( 4 )$$

The probability of having at least one bad motion vector in the set is therefore as expressed in Equation (5) below.

P_{SB}=1−P_{AG} (5)

If N such sets are randomly chosen from the full set of S motion vectors, the probability of all of the chosen sets containing at least one bad motion vector is as expressed in Equation (6) below.

P_{AB}=(1−P_{AG})^{N} (6)

This probability is desirably reduced below some acceptable limit by choosing a suitably large value for N. Given values of G, S and n and a chosen probability threshold P_{AB}^{T} an an appropriate value for N (step 301) can be set, as expressed below in Equation (7).

N=log(P_{AB}^{T})/log(1−P_{AG}) (7)

If G is greater than n, an uncontaminated subset should be available. As G approaches n, however, the number of subsets that need to be tested increases. For a value of G equal to n, all possible subsets must be inspected. Naturally, G is usually only known on average, this value may be a crude estimate.

For each picture in the sequence, the process of generating the set of exact models consists of first selecting a minimal set of motion vectors distinct from any such set previously chosen from this picture (step 302). From this minimal set, a motion model is produced (step 303), which exactly predicts all of the motion vectors in the minimal set.

Sometimes this fitting process fails because the minimal set is not linearly independent. If this happens, another minimal set (step 304) is attempted. The predictions of the model are then compared to each valid motion vector in the picture (step 305) and the magnitude of the difference between the MPEG motion vector and the model prediction is stored in a sorted list.

If the model is based only on good motion vectors, then one can expect that the G of these “prediction errors” to be very small (those corresponding to the good motion vectors). If the model is based in part on bad motion vectors then the G-th ordered magnitude of the “prediction errors” (ordered by increasing magnitude) will be much larger than if all the motion vectors used for the model are good. The G-th error is thus selected from the sorted list of errors (step 306), which is a sensitive measure of whether the model is contaminated. Once all of the models are processed, the model with the lowest G-th error is selected as the “best” model of the exact fit models (step 307).

The G motion vectors from the picture with the smallest prediction error relative to this best model are chosen as the best subset of motion vectors (step 308). This best subset is then used to construct a least-squares model of the motion (step 309). This motion model is then used to characterise the motion underlying the motion vectors for the picture and the parameters of the model along with information about the picture are saved (step 310) into the picture pair model list. The same process is used independently on both the forward and the backward motion vectors (where they exist) for each picture.

For intra-coded pictures (which do not have a reference picture) a B-picture which uses this picture as its reference picture for its backward model is found and the inverse of that model is used as a forward model for the intra-coded picture.

Motion Models

A software framework that allows a user to select from one of a number of progressively more complex motion models is provided: translation only; rotation-translation-zoom; affine and projective. This framework can be easily extended to use other models. The modelling process selects subsets of motion vectors from each picture. The number of motion vectors in each subset is such that an exact fit of the given model to the differential motion is permitted between the pictures.

So, for example, with a pure translation model, a single motion vector is used to “fit” the translation model to the differential motion between the pictures. In this case, the fitting process is quite trivial as the fit is equal to the motion vector. For a rotation-translation-zoom model, two motion vectors provide sufficient information for an exact fit producing a rotation angle and translation vector and a zoom factor. For an affine model, three motion vectors are sufficient for an exact fit to the motion model. For a projective model, four motion vectors are required for an exact fit to the motion model.

For scenes in which the distance to the scene does not vary more than a factor of two or three across the scene, using a 2-D translation model to align successive images is often sufficient. This is particularly the case if, in the compositing step, only a small localized subset of pixels from each image make a significant contribution to the mosaic.

To work within the general framework of the described system, the implementation of the motion model needs to be able to fit a model to both an exact number of unique motion vectors and to fit a least squares motion model to a larger set of motion vectors. The implementation also needs to be able to invert the model and concatenate the model with another model. The mathematical basis of the modelling for each of the models described herein is outlined below.

For the first three models the form for the equations controlling the geometric transformations induced by the camera motion are represented by an equation of the same form, with differing numbers of free parameters. For picture m, the motion between picture n and picture m is modelled as a simple linear transformation. The mathematical form of these models is most simply expressed in homogenous coordinates. Thus for point rₙ in picture n the equivalent point in picture m is calculated as expressed in Equations (8) to (10) below.

rₘ=Aₘₙrₙ (8)

$$\begin{matrix}{\underline{r}}_{m} = [ \begin{matrix}{x}_{m} \\ {y}_{m} \\ 1\end{matrix} ] & ( 9 ) \\ {{A}_{\underline{\_}}}_{mn} = [ \begin{matrix}{a}_{mn} & {b}_{mn} & {δ}_{mn}^{x} \\ {c}_{mn} & {d}_{mn} & {δ}_{mn}^{y} \\ 0 & 0 & 1\end{matrix} ] & ( 10 )\end{matrix}$$

The homogenous coordinates use a dummy component in the position vector so that the transformation can be represented with a simple matrix multiplication. As MPEG information is held in the form of motion vectors, this information is reformulated in a differential motion form as expressed below in Equations (11) to (13).

drₘₙ=dAₘₙrₙ (11)

drₘₙ=rₘ−rₙ (12)

$${{dA}_{\underline{\_}}}_{mn} = {{A}_{\underline{\_}}}_{mn} - {1}_{\underline{\_}} = [ \begin{matrix}{a}_{mn} - 1 & {b}_{mn} & {δ}_{mn}^{x} \\ {c}_{mn} & {d}_{mn} - 1 & {δ}_{mn}^{y} \\ 0 & 0 & 0\end{matrix} ] \qquad ( 13 )$$

For some purposes, manipulation of the model is easier in the standard form rather than in the differential form.

The inverse of this motion model (that is the model of the motion from picture m to picture n) is expressed below in Equations (14) and (15)

drₙₘ=dAₙₘxₘ=(Aₘₙ⁻¹−1)rₘ (14)

dAₙₘ=Aₘₙ⁻¹−1 (15)

The concatenation of the motion model between picture n and picture m with a motion model between picture m and picture k is expressed below in Equations (16) and (17).

drₖₙ=Aₖₘrₘ−rₙ=(AₖₘAₘₙ−1)rₙ=dAₖₙrₙ=dAₖₙrₙ (16)

dAₖₙ=A′ₖₘAₘₙ−1 (17)

Pure Translation Motion Model

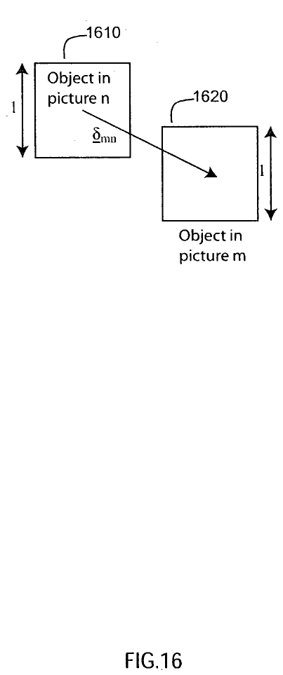

The pure translation model is the simplest motion model. FIG. 16 schematically represents this motion model. The geometrical transformations from one picture to the next are modelled as a simple translation. A unit square in picture n 1610 is assumed to map to a translated unit square in picture m 1620.

For picture n, the motion between picture n and picture m is modelled with a single motion vector as expressed below in Equations (18) and (19).

$$\begin{matrix}{{dA}_{\underline{\_}}}_{mn} = [ \begin{matrix}0 & 0 & {δ}_{mn}^{x} \\ 0 & 0 & {δ}_{mn}^{y} \\ 0 & 0 & 0\end{matrix} ] & ( 18 ) \\ {\underline{dr}}_{mn} = [ \begin{matrix}\underline{{\underline{δ}}_{mn}} \\ 0\end{matrix} ] = [ \begin{matrix}{δ}_{mn}^{x} \\ {δ}_{mn}^{y} \\ 0\end{matrix} ] & ( 19 )\end{matrix}$$

If a set of vectors from picture n which point to the equivalent points in picture m, then for each exact model the motion vectors can remain unchanged to obtain the x and y components of the picture motion. For the least squares fit to a selected set of N motion vectors in picture n, the motion model parameters are as expressed in Equations (20) and (21) below.

$$\begin{matrix}{\underline{δ}}_{mn} = \frac{{\sum }_{i = 1}^{N} {\underline{d}}_{mn}^{i}}{N} & ( 20 ) \\ {\underline{d}}_{mn}^{i} = [ \begin{matrix}{d}_{mn}^{xi} \\ {d}_{mn}^{yi}\end{matrix} ] & ( 21 )\end{matrix}$$

In Equation (21) above, dⁱₘₙ is the i-th selected motion vector in picture n. This motion vector is relative to (or references) picture m.

Rotation-Translation-Zoom Motion Model

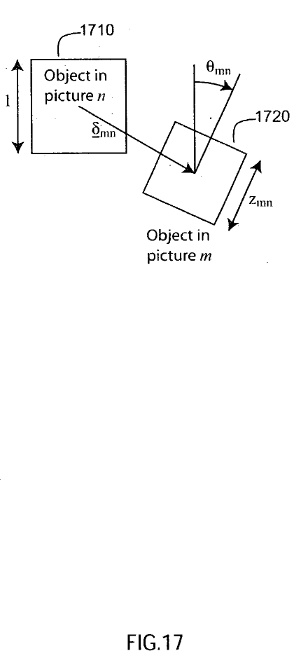

The Rotation-Translation-Zoom (RTZ) motion model schematically represented in FIG. 17, assumes that a unit square in picture n 1710 maps to a rotated, scaled and translated square in picture m 1720.

The homogenous transform matrix for this motion model is of the form expressed in Equation (22) below.

$${{dA}_{\underline{\_}}}_{mn} = [ \begin{matrix}{α}_{mn} - 1 & {β}_{mn} & {δ}_{mn}^{x} \\ - {β}_{mn} & {α}_{mn} - 1 & {δ}_{mn}^{y} \\ 0 & 0 & 0\end{matrix} ] \qquad ( 22 )$$

In Equation 22, the parameters are related to the zoom factor zₘₙ and the rotation angle αₘₙ through Equations

αₘₙ=zₘₙ cos(θₘₙ) (23)

βₘₙ=zₘₙsin(θₘₙ) (24)

So the zoom and rotation angle can be recovered from the parameters defined below in Equations (25) and (26).

zₘₙ=\sqrt{αₘₙ²+βₘₙ²} (25)

θₘₙarc tan(βₘₙ,αₘₙ) (26)

In Equation (26) above, the arctan function takes two arguments and returns a value between −π and π.

With two motion vectors dᵢ, dⱼ located at rᵢ, rⱼ in picture n, the parameters for an exact motion model can be found from Equation (27) below.

$$[ \begin{matrix}α - 1 \\ β \\ {δ}^{x} \\ {δ}^{y}\end{matrix} ] = {[ \begin{matrix}{x}_{i} & {y}_{i} & 1 & 0 \\ {y}_{i} & - {x}_{i} & 0 & 1 \\ {x}_{j} & {y}_{j} & 1 & 0 \\ {y}_{j} & - {x}_{j} & 0 & 1\end{matrix} ]}^{- 1} [ \begin{matrix}{d}_{i}^{x} \\ {d}_{i}^{y} \\ {d}_{j}^{x} \\ {d}_{j}^{y}\end{matrix} ] \qquad ( 27 )$$

In Equation (27) above, the m and n indices are omitted for succinctness.

When a larger number of motion vectors are used, the least squares fit to the motion vectors can be found from Equation (28) below

$$[ \begin{matrix}α - 1 \\ β \\ {δ}^{x} \\ {δ}^{y}\end{matrix} ] = {[ \begin{matrix}{\sum }_{i} {x}_{i}^{2} + {y}_{i}^{2} & 0 & {\sum }_{i} {x}_{i} & {\sum }_{i} {y}_{i} \\ 0 & {\sum }_{i} {x}_{i}^{2} + {y}_{i}^{2} & {\sum }_{i} {y}_{i} & - {\sum }_{i} {x}_{i} \\ {\sum }_{i} {x}_{i} & {\sum }_{i} {y}_{i} & {\sum }_{i} 1 & 0 \\ {\sum }_{i} {y}_{i} & - {\sum }_{i} {x}_{i} & 0 & {\sum }_{i} 1\end{matrix} ]}^{- 1} [ \begin{matrix}{\sum }_{i} {x}_{i} {d}_{i}^{x} + {y}_{i} {d}_{i}^{y} \\ {\sum }_{i} {y}_{i} {d}_{i}^{x} - {x}_{i} {d}_{i}^{y} \\ {\sum }_{i} {d}_{i}^{x} \\ {\sum }_{i} {d}_{i}^{y}\end{matrix} ] \qquad ( 28 )$$

Affine Motion Model

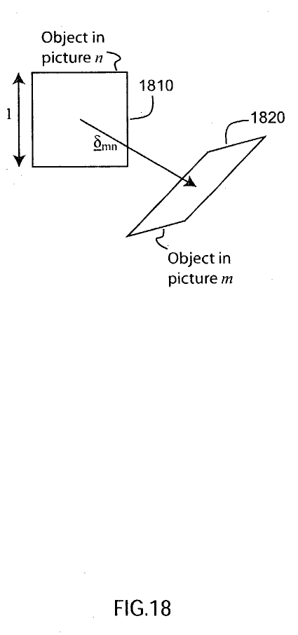

The Affine motion model, schematically represented in FIG. 18, assumes that a unit square in picture n 1810 maps to a rotated, scaled, translated and skewed square in picture m 1820.

The relationship of the transform parameters to the geometrical properties of the transformed figure is not as obvious as it is for the RTZ model.

The homogenous transform matrix for this motion model can be written in the form expressed below in Equation (29).

$${{dA}_{\underline{\_}}}_{mn} = [ \begin{matrix}{α}_{mn} + {γ}_{mn} - 1 & {β}_{mn} + {ϵ}_{mn} & {δ}_{mn}^{x} \\ {ϵ}_{mn} - {β}_{mn} & {α}_{mn} - {γ}_{mn} - 1 & {δ}_{mn}^{y} \\ 0 & 0 & 0\end{matrix} ] \qquad ( 29 )$$

The two new parameters γₘₙ and εₘₙ produce the x and y axis skew. For convenience, the parameters are related to a zoom factor zₘₙ and a rotation angle αₘₙ through Equation (30) and (31) expressed below.

αₘₙ, =zₘₙ cos(θₘₙ) (30)

βₘₙ=zₘₙ sin(θₘₙ) (31)

In Equations (30) and (31) above, if the two skew parameters are zero, this transformation equates to a simple zoom and rotation. If the skew parameters are not zero, however, the interpretation of these parameters is more difficult.

With three motion vectors dᵢ dⱼ dₖ located at rᵢ,rⱼ,rₖ in picture n, which indicates that the displacement to equivalent positions in picture m the parameters for an exact motion model can be found from Equation (32) below.

$$[ \begin{matrix}α - 1 \\ β \\ γ \\ ϵ \\ {δ}^{x} \\ {δ}^{y}\end{matrix} ] = {[ \begin{matrix}{x}_{i} & {y}_{i} & 0 & 0 & 1 & 0 \\ 0 & 0 & {x}_{i} & {y}_{i} & 0 & 1 \\ {x}_{j} & {y}_{j} & 0 & 0 & 1 & 0 \\ 0 & 0 & {x}_{j} & {y}_{j} & 0 & 1 \\ {x}_{k} & {y}_{k} & 0 & 0 & 1 & 0 \\ 0 & 0 & {x}_{k} & {y}_{k} & 0 & 1\end{matrix} ]}^{- 1} [ \begin{matrix}{d}_{i}^{x} \\ {d}_{i}^{y} \\ {d}_{j}^{x} \\ {d}_{j}^{y} \\ {d}_{k}^{x} \\ {d}_{k}^{y}\end{matrix} ] \qquad ( 32 )$$

In Equation (32) above, the m and n indices are omitted for succinctness.

When a larger number of motion vectors are used the least squares fit to the motion vectors can be found by solving Equation (33) below.

$$[ \begin{matrix}α - 1 \\ β \\ γ \\ ϵ \\ {δ}^{x} \\ {δ}^{y}\end{matrix} ] = {[ \begin{matrix}{\sum }_{i} ( {x}_{i}^{2} + {y}_{i}^{2} ) & 0 & {\sum }_{i} ( {x}_{i}^{2} - {y}_{i}^{2} ) & {\sum }_{i} 2 {x}_{i} {y}_{i} & {\sum }_{i} {x}_{i} & {\sum }_{i} {y}_{i} \\ 0 & {\sum }_{i} ( {y}_{i}^{2} + {x}_{i}^{2} ) & {\sum }_{i} 2 {x}_{i} {y}_{i} & {\sum }_{i} ( {y}_{i}^{2} - {x}_{i}^{2} ) & {\sum }_{i} {y}_{i} & - {\sum }_{i} {x}_{i} \\ {\sum }_{i} ( {x}_{i}^{2} - {y}_{i}^{2} ) & {\sum }_{i} 2 {x}_{i} {y}_{i} & {\sum }_{i} ( {x}_{i}^{2} + {y}_{i}^{2} ) & 0 & {\sum }_{i} {x}_{i} & - {\sum }_{i} {y}_{i} \\ {\sum }_{i} 2 {x}_{i} {y}_{i} & {\sum }_{i} ( {y}_{i}^{2} - {x}_{i}^{2} ) & 0 & {\sum }_{i} ( {y}_{i}^{2} + {x}_{i}^{2} ) & {\sum }_{i} {y}_{i} & {\sum }_{i} {x}_{i} \\ {\sum }_{i} {x}_{i} & {\sum }_{i} {y}_{i} & {\sum }_{i} {x}_{i} & {\sum }_{i} {y}_{i} & {\sum }_{i} 1 & 0 \\ {\sum }_{i} {y}_{i} & - {\sum }_{i} {x}_{i} & - {\sum }_{i} {y}_{i} & {\sum }_{i} {x}_{i} & 0 & {\sum }_{i} 1\end{matrix} ]}^{- 1} [ \begin{matrix}{\sum }_{i} {x}_{i} {d}_{i}^{x} + {y}_{i} {d}_{i}^{y} \\ {\sum }_{i} {y}_{i} {d}_{i}^{x} - {x}_{i} {d}_{i}^{y} \\ {\sum }_{i} {x}_{i} {d}_{i}^{x} - {y}_{i} {d}_{i}^{y} \\ {\sum }_{i} {y}_{i} {d}_{i}^{x} + {x}_{i} {d}_{i}^{y} \\ {\sum }_{i} {d}_{i}^{x} \\ {\sum }_{i} {d}_{i}^{y}\end{matrix} ] \qquad ( 33 )$$

Projective Transform Motion Model

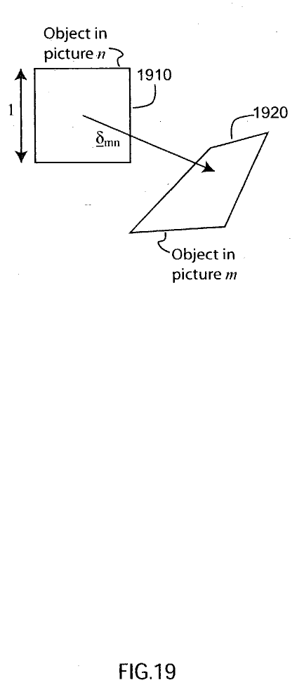

The projective transform, schematically represented in FIG. 19, allows for an accurate representation of the transform geometry of an ideal (pin hole) camera's effect on an image when that camera is subject to camera rotations and changes in focal length. A unit square 1910 is transformed to a general quadrilateral 1920 by the projective transform

The form of the equation governing the projective transform is expressed below in Equation (34).

$${\underline{r}}_{m} = \frac{{{A}_{\underline{\_}}}_{mn} {\underline{r}}_{n}}{{\underline{c}}_{mn}^{T} {\underline{r}}_{n}} \qquad ( 34 )$$

In expanded form using homogenous coordinates, Equation (35) becomes Equation (35) below.

$$[ \begin{matrix}{x}_{m} \\ {y}_{m} \\ 1\end{matrix} ] = \frac{[ \begin{matrix}{a}_{mn}^{00} & {a}_{mn}^{01} & {δ}_{mn}^{x} \\ {a}_{mn}^{10} & {a}_{mn}^{11} & {δ}_{mn}^{y} \\ 0 & 0 & 1\end{matrix} ] [ \begin{matrix}{x}_{n} \\ {y}_{n} \\ 1\end{matrix} ]}{[ \begin{matrix}{c}_{mn}^{0} & {c}_{mn}^{1} & 1\end{matrix} ] [ \begin{matrix}{x}_{n} \\ {y}_{n} \\ 1\end{matrix} ]} \qquad ( 35 )$$

For convenience, Equation (35) is rearranged as Equation (36) below.

$$[ \begin{matrix}{x}_{m} \\ {y}_{m}\end{matrix} ] = [ \begin{matrix}{x}_{n} & 0 & {y}_{n} & 0 & 1 & 0 & - {x}_{n} {x}_{m} & - {y}_{n} {x}_{m} \\ 0 & {x}_{n} & 0 & {y}_{n} & 0 & 1 & - {x}_{n} {y}_{m} & - {y}_{n} {y}_{m}\end{matrix} ] [ \begin{matrix}{a}_{mn}^{00} \\ {a}_{mn}^{10} \\ {a}_{mn}^{01} \\ {a}_{mn}^{11} \\ {δ}_{mn}^{x} \\ {δ}_{mn}^{y} \\ {c}_{mn}^{0} \\ {c}_{mn}^{1}\end{matrix} ] \qquad ( 36 )$$

So, if four suitable point pairs exist (as per Equation (37) below), then an exact fit to the model can be found by solving Equation (38) below.

$$\begin{matrix}( [ \begin{matrix}{x}_{m}^{i} \\ {y}_{m}^{i}\end{matrix} ] , [ \begin{matrix}{x}_{n}^{i} \\ {y}_{n}^{i}\end{matrix} ] ) … i = 0 … 3 & ( 37 ) \\ [ \begin{matrix}{a}_{mn}^{00} \\ {a}_{mn}^{10} \\ {a}_{mn}^{01} \\ {a}_{mn}^{11} \\ {δ}_{mn}^{x} \\ {δ}_{mn}^{y} \\ {c}_{mn}^{0} \\ {c}_{mn}^{1}\end{matrix} ] = {[ \begin{matrix}{x}_{n}^{0} & 0 & {y}_{n}^{0} & 0 & 1 & 0 & - {x}_{n}^{0} {x}_{m}^{0} & - {y}_{n}^{0} {x}_{m}^{0} \\ 0 & {x}_{n}^{0} & 0 & {y}_{n}^{0} & 0 & 1 & - {x}_{n}^{0} {y}_{m}^{0} & - {y}_{n}^{0} {y}_{m}^{0} \\ {x}_{n}^{1} & 0 & {y}_{n}^{1} & 0 & 1 & 0 & - {x}_{n}^{1} {x}_{m}^{1} & - {y}_{n}^{1} {x}_{m}^{1} \\ 0 & {x}_{n}^{1} & 0 & {y}_{n}^{1} & 0 & 1 & - {x}_{n}^{1} {y}_{m}^{1} & - {y}_{n}^{1} {y}_{m}^{1} \\ {x}_{n}^{2} & 0 & {y}_{n}^{2} & 0 & 1 & 0 & - {x}_{n}^{2} {x}_{m}^{2} & - {y}_{n}^{2} {x}_{m}^{2} \\ 0 & {x}_{n}^{2} & 0 & {y}_{n}^{2} & 0 & 1 & - {x}_{n}^{2} {y}_{m}^{2} & - {y}_{n}^{2} {y}_{m}^{2} \\ {x}_{n}^{3} & 0 & {y}_{n}^{3} & 0 & 1 & 0 & - {x}_{n}^{3} {x}_{m}^{3} & - {y}_{n}^{3} {x}_{m}^{3} \\ 0 & {x}_{n}^{3} & 0 & {y}_{n}^{3} & 0 & 1 & - {x}_{n}^{3} {y}_{m}^{3} & - {y}_{n}^{3} {y}_{m}^{3}\end{matrix} ]}^{- 1} [ \begin{matrix}{x}_{m}^{0} \\ {y}_{m}^{0} \\ {x}_{m}^{1} \\ {y}_{m}^{1} \\ {x}_{m}^{2} \\ {y}_{m}^{2} \\ {x}_{m}^{3} \\ {y}_{m}^{3}\end{matrix} ] & ( 38 )\end{matrix}$$

When a larger number of motion vectors are used, a least squares solution is required to fit the motion vectors. This model has a non-linear dependence on some of the model parameters. Strictly speaking, a non-linear solver should be used to fit the parameters. Provided the errors on the data points are not too large, however, a quick solution can be found by solving the linear form of Equation (39) below.

$$[ \begin{matrix}{a}_{mn}^{00} \\ {a}_{mn}^{10} \\ {a}_{mn}^{01} \\ {a}_{mn}^{11} \\ {δ}_{mn}^{x} \\ {δ}_{mn}^{y} \\ {c}_{mn}^{0} \\ {c}_{mn}^{1}\end{matrix} ] = {[ \begin{matrix}{\sum }_{i} {( {x}_{n}^{i} )}^{2} & 0 & {\sum }_{i} {x}_{n}^{i} {y}_{n}^{i} & 0 & {\sum }_{i} {x}_{n}^{i} & 0 & - {\sum }_{i} {( {x}_{n}^{i} )}^{2} {x}_{m}^{i} & - {\sum }_{i} {x}_{n}^{i} {y}_{n}^{i} {x}_{m}^{i} \\ 0 & {\sum }_{i} {( {x}_{n}^{i} )}^{2} & 0 & {\sum }_{i} {x}_{n}^{i} {y}_{n}^{i} & 0 & {\sum }_{i} {x}_{n}^{i} & - {\sum }_{i} {( {x}_{n}^{i} )}^{2} {y}_{m}^{i} & - {\sum }_{i} {x}_{n}^{i} {y}_{n}^{i} {y}_{m}^{i} \\ {\sum }_{i} {x}_{n}^{i} {y}_{n}^{i} & 0 & {\sum }_{i} {( {y}_{n}^{i} )}^{2} & 0 & {\sum }_{i} {y}_{n}^{i} & 0 & - {\sum }_{i} {x}_{n}^{i} {y}_{n}^{i} {x}_{m}^{i} & - {\sum }_{i} {( {y}_{n}^{i} )}^{2} {y}_{m}^{i} \\ 0 & {\sum }_{i} {x}_{n}^{i} {y}_{n}^{i} & 0 & {\sum }_{i} {( {y}_{n}^{i} )}^{2} & 0 & {\sum }_{i} {y}_{n}^{i} & - {\sum }_{i} {x}_{n}^{i} {y}_{n}^{i} {y}_{m}^{i} & - {\sum }_{i} {( {y}_{n}^{i} )}^{2} {y}_{m}^{i} \\ {\sum }_{i} {x}_{n}^{i} & 0 & {\sum }_{i} {y}_{n}^{i} & 0 & {\sum }_{i} 1 & 0 & - {\sum }_{i} {x}_{n}^{i} {x}_{m}^{i} & - {\sum }_{i} {y}_{n}^{i} {x}_{m}^{i} \\ 0 & {\sum }_{i} {x}_{n}^{i} & 0 & {\sum }_{i} {y}_{n}^{i} & 0 & {\sum }_{i} 1 & - {\sum }_{i} {x}_{n}^{i} {y}_{m}^{i} & - {\sum }_{i} {y}_{n}^{i} {y}_{m}^{i} \\ - {\sum }_{i} {( {x}_{n}^{i} )}^{2} {x}_{m}^{i} & 0 & - {\sum }_{i} {x}_{n}^{i} {y}_{n}^{i} {x}_{m}^{i} & 0 & - {\sum }_{i} {x}_{n}^{i} {x}_{m}^{i} & 0 & {\sum }_{i} {( {x}_{n}^{i} {x}_{m}^{i} )}^{2} & - {\sum }_{i} {x}_{n}^{i} {{y}_{n}^{i} ( {x}_{m}^{i} )}^{2} \\ 0 & - {\sum }_{i} {x}_{n}^{i} {y}_{n}^{i} {y}_{m}^{i} & 0 & - {\sum }_{i} {( {y}_{n}^{i} )}^{2} {y}_{m}^{i} & 0 & - {\sum }_{i} {y}_{n}^{i} {y}_{m}^{i} & {\sum }_{i} {x}_{n}^{i} {{y}_{n}^{i} ( {y}_{m}^{i} )}^{2} & - {\sum }_{i} {( {y}_{n}^{i} {y}_{m}^{i} )}^{2}\end{matrix} ]}^{- 1} [ \begin{matrix}{\sum }_{i} {x}_{n}^{i} {x}_{m}^{i} \\ {\sum }_{i} {x}_{n}^{i} {y}_{m}^{i} \\ {\sum }_{i} {y}_{n}^{i} {x}_{m}^{i} \\ {\sum }_{i} {y}_{n}^{i} {y}_{m}^{i} \\ {\sum }_{i} {x}_{m}^{i} \\ {\sum }_{i} {y}_{m}^{i} \\ {- \sum }_{i} {{x}_{n}^{i} ( {x}_{m}^{i} )}^{2} \\ - {\sum }_{i} {{y}_{n}^{i} ( {y}_{m}^{i} )}^{2}\end{matrix} ] \qquad ( 39 )$$

The disadvantage of this “linearization” of the problem is that the [xₘⁱyₘⁱ]^{T} values are treated as independent, whereas these values are in fact dependent on [xₙⁱyₙⁱ]^{T}. Consequently, the fitted model does not minimise the squared error between the transformed positions and the predictions of the projective transform function of Equation (35) which is a function of only the input positions. The squared error is, however, minimized with respect to a simpler linear function of Equation (36) of both the measured input positions and output positions. The resulting parameters can then be used in the projective transform function of Equation (35) to perform prediction based only on input positions. For many purposes, the result is acceptable and the process is much faster than using a non-linear solver. If speed is not a particular issue, or accuracy is a priority, then a solution can be obtained to the non-linear problem using standard techniques.

Model Concatenation

The “Picture-to-picture” motion models generated by the “Robust Motion Modeling Subsystem” characterize the geometric transformation between a P- or B-picture and its reference picture for any P- or B-picture with a sufficient number of macroblocks to form a model. To efficiently register all of the pictures in a sequence to a single coordinate system, a “reference model” must be generated for each picture in the sequence that characterizes the transformation required to map a picture into the chosen coordinate system. A “motion connected” portion of a sequence is a contiguous set of pictures that can be connected to each other by a series of reference motion models.

After backward and forward models are constructed for pictures that have sufficient motion vectors to produce a model, the series of backward and forward motion models are concatenated so that where possible, these models can be unambiguously related to a common reference picture. The chief problem addressed in achieving these objectives involves handling the various cases in which either or both of the backward or forward motion models for a given picture may be absent. By carefully designing the algorithm to handle all possible situations, the number of pictures that can be joined in a motion connected subsequence is maximized. The result is a series of contiguous subsequences, in which each picture has a motion model relative to a single reference picture within the subsequence.

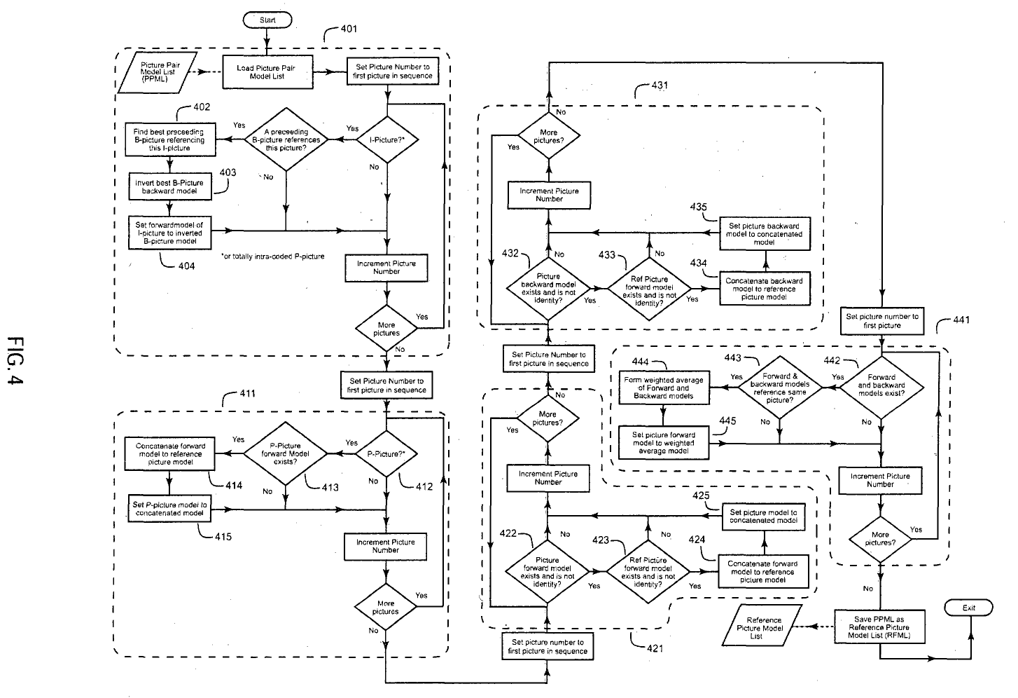

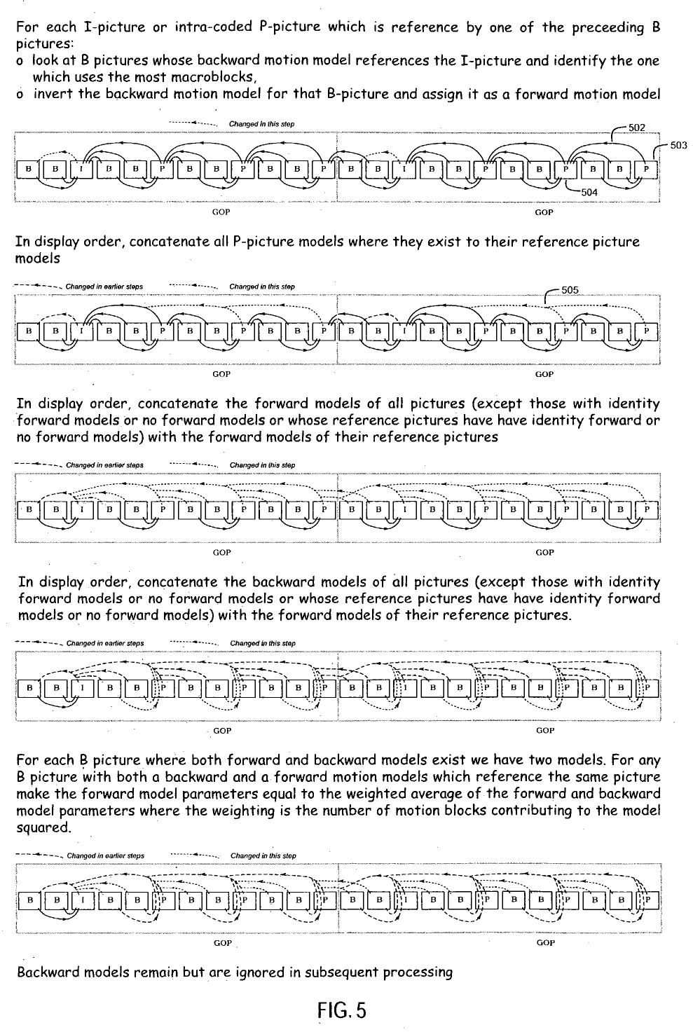

FIG. 4 flowcharts, and the series of diagrams in FIG. 5 illustrates the process whereby the models in a sequence are concatenated to form motion-connected subsequences. At the stage immediately prior to that represented by these figures forward and backward models are constructed for each P- and B-picture that has sufficient motion vectors to allow a reliable model to be constructed. For the I-pictures a dummy forward model, which references itself and a null backward model (indicating that the model does not exist), is inserted.

FIG. 4 is divided into five major segments, which are applied sequentially to all of the pictures in the sequence.

In the first segment (step 401) the I-pictures are each provided with a forward model by examining the immediately preceding B-pictures which use that I-picture as a reference picture for their backward model. The best model is selected (step 402) and inverted (step 403) to provide a forward model for the said I-picture (step 404).

In the second segment (step 411), all of the pictures in the sequence are examined in display order to identify the P-pictures (step 412). If a P-picture has a forward model (step 413), then the forward model is concatenated for said picture with the forward model for said reference picture (step 414) and the forward model is set for the said P-picture to the resulting concatenated model (step 415).

In the third segment (step 421), the pictures are examined in the sequence in display order and those pictures in the sequence that have a forward model that is not an identity model (mapping each point to itself) (step 422) are identified. For each such picture, those pictures whose reference picture has a forward model that is not an identity model (step 423) are identified. This picture is concatenated with the forward model for the said reference picture (step 424) and the forward model is set for the said picture to the resulting concatenated model (step 425).

In the fourth segment (step 431), the pictures are examined in the sequence in display order and those pictures in the sequence that have a backward model that is not an identity model (step 432) are identified. For each such picture, those pictures are identified whose reference picture has a forward model that is not an identity model (step 433). This picture is concatenated with the forward model for the said reference picture (step 434) and the backward model is set for the said picture to the resulting concatenated model (step 435).

In the fifth segment (step 441), the pictures in the sequence are examined in display order and those pictures are identified for which both forward and backward models exist (step 442), and for which both the forward and backward models reference the same picture (step 443). The weighted average of the forward and backward models is formed with a weighting proportional to the number of macro-blocks contributing to the two models (step 444). The forward model is set for the said picture to the resulting average model (step 445).

The models resulting from this series of operations are saved as the Reference Picture Model List (step 450).

FIG. 5 schematically represents the concatenation process, which is illustrated with a series of diagrams illustrating the changes made to the models on a series of pictures. Each directed path (step 502) represents a model for the picture (step 503) at the start of the path using the picture at the termination of the path (step 504) as its reference picture. Concatenation of a model with another model is represented in FIG. 5 by joining the path representing the first model to the path representing the second model (step 505). Line styles are used to highlight the order of operations.

The concatenation process produces a model for each picture in a motion-connected subsequence. This model maps from the picture to a fixed reference picture or to a coordinated system with a known mapping to a fixed reference picture. These reference models are referred to as Tₙ(●). In general, this model is a function that maps coordinates in picture n to the coordinates of the same point in the reference coordinate system such that

rᵣ=Tₙ(rₙ) (40)

From these reference models, an Estimated Picture Pair Motion Model can be constructed between any two pictures in the sequence as per Equation (41) below.

rⱼ=Tₘ(Tₙ(rₙ)) (41)

The concatenated transform can be succinctly expressed as per Equation (42) below.

tₘₙ(●)=Tₘ⁻¹(Tₙ(●)) (42)

This estimated motion model maps the coordinates of a point in the coordinate system of picture n, to the coordinates of the equivalent point in the coordinate system of picture m.

Subsequence Partitioning

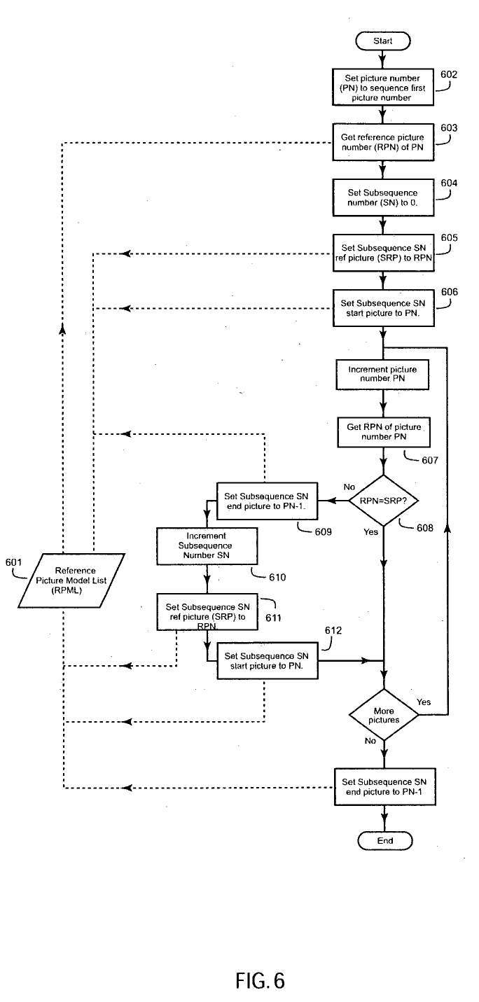

After the models have been concatenated, the sequence is partitioned into motion connected subsequences. FIG. 6 flowcharts this process. This subsystem uses the Reference Picture Model List (step 601) produced from the concatenation process. The system examines the first picture and initialises the Picture Number (PN) to the picture number of the first picture in the sequence (step 602). The system then gets the reference picture number for the first picture (RPN) (step 603) and initializes the subsequence number to 0 (step 604) and initializes the subsequence reference picture number (SRP) to the reference picture number for the first picture (step 605). The start picture number for the first subsequence is then set to the picture number of the first picture (step 606).

After the initialization phase, each picture in the sequence is examined in display order and its reference picture number obtained (step 607) and compared to the current subsequence reference picture number (step 608). If these values are different, then the subsequence is deemed to have ended and the subsequence end picture is set to the number for the previous picture in the sequence (step 609). The subsequence number is incremented (step 610) and the subsequence reference picture number for the new subsequence is set to the reference picture number for the current picture (step 611) and the start picture for the new subsequence is set to the picture number for the current picture (step 612). This process continues until all pictures are examined, and results in partitioning information being added to the Reference Picture Model List.

Model Refinement

In MPEG video, the motion information is only encoded to ½ pixel accuracy at best. The picture-to-picture motion models from the robust motion modelling subsystem cannot therefore be appreciably more accurate than this. When these models are concatenated, errors in the picture-to-picture motion models tend to aggregate and accumulate. In long subsequences, the motion models for some pictures require the concatenation of many picture-to-picture models. The resulting errors in the reference models from this process can be large enough to produce quite significant errors in the registration of pictures that overlap spatially but are separated in the sequence by many pictures.

For some applications, alignment of any overlapping pictures needs to be much better than can be achieved from the MPEG motion vectors alone. This is the case, for example, in super-resolved mosaics (which achieve higher resolution than the original video pictures) and in zigzag panned mosaics (in which the camera pans back and forth over a scene to extend the captured area in both dimensions).

Fortunately, the models produced from the robust fitting process provide a good starting point for a model refinement process. As the robust fitting process can also provide a list of macroblocks whose motion vectors agree well with the predictions of the fitted motion model, the basis for an efficient process is available for refining the motion model using reliable image information and a good initial estimate of the motion.

This refinement process can also be used to provide a better motion model for picture pairs with a significant overlap but for which the original MPEG video does not provide motion vectors. Such pictures are often well separated in the video sequence and are therefore likely to produce a poor motion model from the model concatenation process.

The refinement process starts by first supplementing the Picture Pair Model List with any additional picture pairs for which the user may wish to produce a model refinement. This step is not essential to the model refinement process. However, if the user wishes to take advantage of the Global Registration Sub-system, then this is the point at which key picture pairs that overlap but are well separated in the sequence can be provided with an accurate picture-to-picture motion model. This accurate picture-to-picture motion model provides reference points that constrain the Global Registration Sub-system when the sub-system performs its optimised redistribution of the registration inconsistencies.

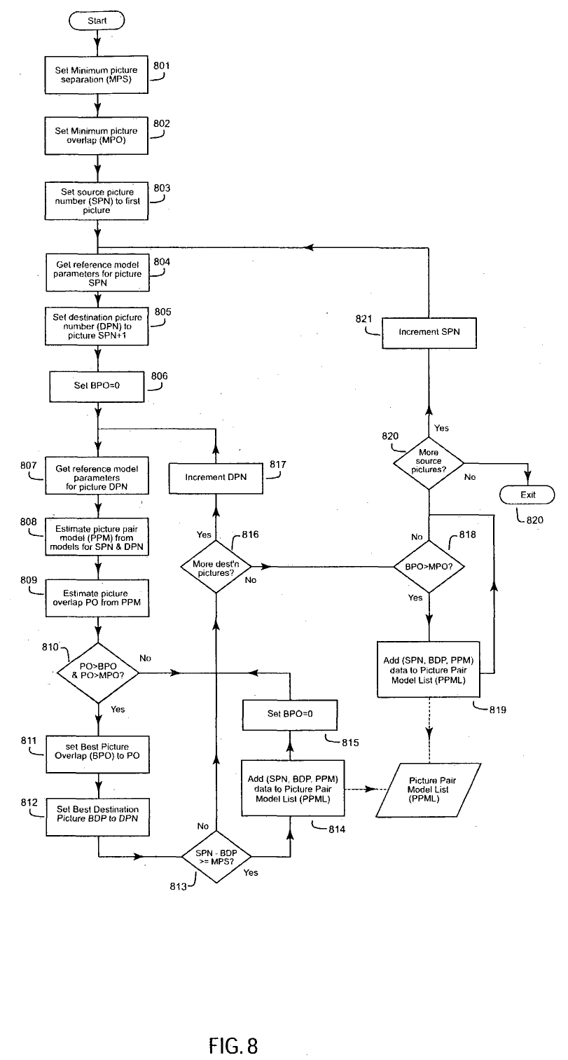

There are many ways in which the supplemental picture pairs might be chosen. FIG. 8 flowcharts one possible selection process. The process seeks to find picture pairs that are separated in the sequence by more than a threshold number of pictures but overlap more than some threshold percentage of overlap (based on the Estimated Picture Pair Motion Model).

The process initially sets the Minimum Picture Separation (MPS) (step 801) and sets the Minimum Picture Overlap (step 802). The source picture for the picture pair is then set to the first picture in the sequence (step 803) and the reference model for that picture is obtained (step 804). The destination picture for the picture pair is then set to the next picture after the source picture (step 805) and the Best Picture Overlap is initialised to zero (step 806). The Reference Model for the destination picture is then obtained (step 807) and an Estimated Picture Pair Model is constructed (step 808).

This model is then used to estimate the picture overlap for the picture pair (step 809). If the picture overlap is greater than the minimum picture overlap and greater than the best picture overlap (step 810), then set the best picture overlap to the current picture overlap (step 811) and set the best destination picture to the current destination picture (step 812). If the picture separation is greater than the minimum picture separation (step 813), then save the parameters for the picture pair (step 814), reset the best picture, offset (step 815) and rejoin the control stream (step 816) from the negative paths of the previous conditional tests. If there are more destination pictures (step 816) then increment the destination picture number (step 817) and continue testing destination pictures as above.

If there are no more destination pictures then check to see if the current best picture offset is greater than the minimum picture offset (step 818) and, if so, save the picture pair parameters (step 819). If it is not, then check to see if there are more source pictures (step 820). If there are more source pictures then increment the source picture number (step 821) and continue forming picture pairs and testing them. If not, then exit (step 822).

Once the Picture-to-picture Model list has been supplemented, the model refinement sub-system processes each picture pair in sequence. For each picture pair, the sub-system first obtains the estimated picture pair model (step 702), then finds a subset of edge pixels (step 703) in the first or source pictures of the picture pair. There are many ways of choosing the edge pixels, but the procedure described below is used as some information is already available to assist in efficiently identify any regions of the picture which have good edge information and motion that matches the modelled motion reasonably well.

The edge pixels are chosen from macroblocks having MPEG motion vectors that are well matched to the predictions of the estimated motion model. If one of the pictures is a P- or B-picture then these macroblocks have motion vectors from which a set of motion vectors can be selected. If both of the pictures are I-pictures, then there are no motion vectors available directly from either picture.

Motion vectors can still possibly be used from a neighbouring picture, and the estimated motion model can be used to map those into one of the picture pairs to select the candidate macroblocks. From each candidate macroblock in the source picture, the edge pixel with the maximum intensity gradient is chosen as the representative edge pixel for the macroblock.

The optimization process for (step 704) uses an error measure, such as the sum of the absolute differences between the intensity values at each of the source pixels and the intensity at the resulting mapped location in the destination picture. Equation (43) recites such an example.

$$σ = {\sum }_{i} \vert {I}_{n} ( {\underline{r}}_{n}^{i} ) - {I}_{m} ( {t}_{mn} ( {\underline{r}}_{n}^{i} ) ) \vert \qquad ( 43 )$$

Equation (43) is used to estimate the quality of the geometric transformation function. A standard optimisation technique such as gradient descent or conjugate gradients or a simplex method is then used to optimize the parameters of the mapping function to minimize the error measure σ. The resulting model parameters replace the existing model parameters (step 705). The process is repeated for each picture pair.

Global Registration

From the MPEG motion vectors a set of picture-to-picture motion models is provided by the robust fitting process. What is found is that registration errors in the picture-to-picture model set tend to accumulate in the concatenation process to produce significant and visually objectionable alignment errors where pictures overlap spatially, but are well separated in the sequence. The model refinement process can be used to improve the models, but if only the existing picture-to-picture models are refined then the alignment problems with well separated but overlapping picture pairs are improved but may well remain objectionable. The refinement process, however, can be used to refine the estimated model for a pair of pictures for which the MPEG video does not provide motion information. A global registration process can then be used to distribute the inconsistent alignment in such a way that errors are as small as possible everywhere. A set of linear equations is derived from minimising a measure of the differences between the measured picture-to-picture transforms and the equivalent transforms derived from the reference transforms.

If the supplemented set of picture-to-picture models is tₘₙ⁰(●), the set of estimated reference models from the concatenation process is Tₙ(●) and the set of estimated picture-to-picture models formed from the reference models is tₘₙ(●). A measure of the registration consistency can then be formed for a given picture based on all picture pairs which contain the picture as a source or destination picture. One way to do this is to use a fixed sampling {rᵢ} . . . i=0 . . . k of the first picture of a picture pair and map these sampled points to form a measure of the registration consistency of the form expressed in Equation (44) below.

$$\begin{matrix}{g}_{mn} = {\sum }_{p ( p \neq m )} {\sum }_{i} {‖ {t}_{np}^{0} ( {t}_{pn} ( {\underline{r}}_{i} ) ) ‖}^{2} + {\sum }_{q} {\sum }_{i} {‖ {t}_{mq}^{0} ( {t}_{qm} ( {\underline{r}}_{i} ) ) ‖}^{2} \\ = {\sum }_{p ( p \neq m )} {\sum }_{i} {‖ {t}_{np}^{0} ( {T}_{p}^{- 1} ( {T}_{n} ( {\underline{r}}_{i} ) ) ) ‖}^{2} + {\sum }_{q} {\sum }_{i} {‖ {t}_{qm}^{0} ( {T}_{m}^{- 1} ( {T}_{q} ( {\underline{r}}_{i} ) ) ) ‖}^{2}\end{matrix} \qquad ( 44 )$$

In Equation (44), the models tₙₚ⁰(●) are the inverse of the saved model tₚₙ⁰(●) if the stored picture pair model has picture p as the destination picture rather than the source picture and t_{qm}⁰(●) is the inverse of the saved model t_{mq}⁰(●) if the stored model has picture q as the destination picture rather than the source picture. The sum is taken over all of the sample vectors and over all pictures connected to picture m or picture n by a motion model in the Picture Pair Model List.

This measure is large for a small number of picture pairs in the set (usually the pairs added in the supplementation process) and small or zero for the large proportion of the pairs which were in the set used in the concatenation process. A global consistency measure is formed, as expressed in Equation (45).

$$G = {\sum }_{m , n} {g}_{mn} \qquad ( 45 )$$

In Equation (45), the sum is taken over all picture pairs (m,n) in the Picture Pair Model List. The reference models Tₙ(●) are then adjusted to minimize this measure. This redistributes the inconsistency in such a way that a large number of picture pairs suffer a small increase in their inconsistency measure while the small number with large inconsistency are reduced significantly.

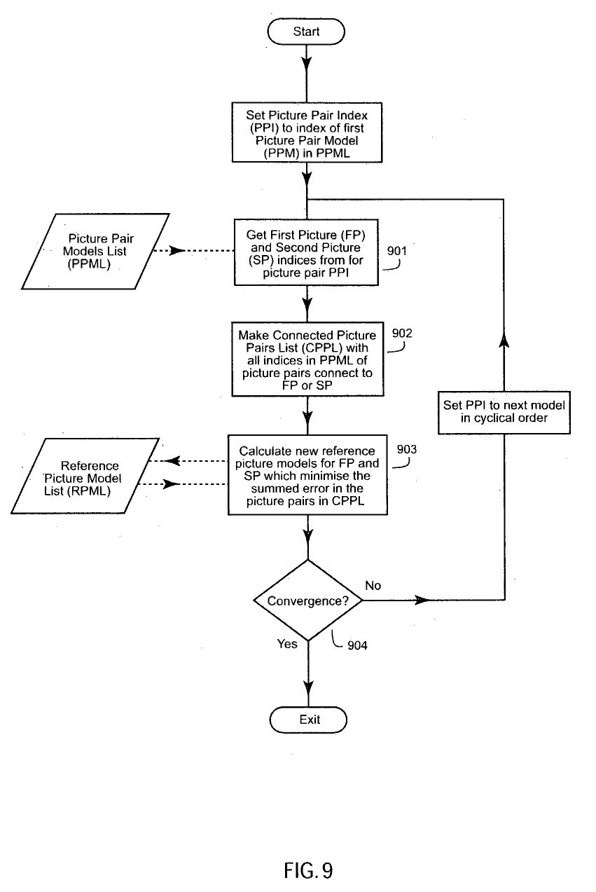

This optimization problem can be solved using a simple iterative process. FIG. 9 flowcharts this process. For each picture pair (m,n) in the Picture Pair Model List the first and second pictures in the picture pair model (step 901) are identified, and the list of pictures connected to either picture m or picture n by a model in the Picture Pair Model List are found and stored in a Connected Picture Pairs List (step 902). The small linear problem of finding the reference models Tₘ(●), Tₙ(●) is solved by minimizing the inconsistency measure gₘₙ(step 903). This process is iterated over all of the picture pairs in the Picture Pair Model List until the process converges to produce something close to the set of globally most consistent reference models Tₖ(●) (step 904).

Global Intensity Correction

The intensity correction sub-system finds a set of intensity corrections for each picture in the sequence that corrects for intensity changes resulting from changes in the lighting conditions and the effects of automatic gain control. The intent is that the overlapping parts of any pictures exhibit intensity in the overlapping region that is as similar as possible. The overlapping portion of all image pairs in which the proportion of overlap falls within a desired range are used to set up a system of linear equations which transform the pixel value of each picture of the sequence. The parameters for each transformation are optimised to minimise the sum of the squared differences of the intensity component of the overlapping regions of all of the picture pairs.

A set of intensity transformations which modify the intensity component of the pixel information each picture is first formed such that the intensity at any point in picture n after the application of this transformation is as expressed in Equation (46) below.

Iₙ*(rₙⁱ)=gₙ(rₙⁱ)Iₙ(rₙⁱ) (46)

In Equation (46) above, for the purposes of determining the intensity transform functions gₙ(●), the intensity Iₙ*(rₙⁱ) can be the actual pixel intensity, but can also be an interpolated intensity, calculated from the average values of pixel intensity over the blocks in the neighbourhood of the sample. As the modelled intensity transformation slowly varies over the picture, these interpolated values generally provide as good an estimate of the intensity variation as the pixel intensity values, and have the advantage that the image information does not need to be fully decoded to recover these average values. The DC components of the cosine transform components for all of the macroblocks for each picture can be extracted without decoding the whole image. For the I-pictures this provides the average value for each block in the picture directly. For the P- and B-pictures, the motion vector information can be used with the DC-images to estimate the average values where these values are required.

The hue and saturation of the pixel are left unchanged. There are a number of colour representations which separate the intensity or lightness components from the hue and saturation components of the colour in a given picture pixel. The most convenient of these is the (Y,Cb,Cr) colour coordinates used in MPEG for which the “intensity” is the Y component. Of course, any other similar representation such as CIELAB or CIELUV is also acceptable. The function gₙ(●) would typically be a simple parametric function such as a bilinear function and is initially set to equal unity everywhere.

The measure of the intensity mismatch of the overlapping portions in two pictures is constructed from a sampling at a predefined set of points {rₙⁱ} . . . i=0 . . . k within the overlapped portions of the registered pictures so that for pictures n and m the intensity mismatch is expressed in Equation (47) and (48) below.

$${k}_{mn} = {\sum }_{i} \vert {I}_{n}^{*} ( {\underline{r}}_{n}^{i} ) - {I}_{m}^{*} ( {\underline{r}}_{m}^{i} ) \vert \qquad ( 47 )$$

rₘⁱ=tₘₙ(rₙⁱ) (48)

A global measure of the intensity mismatch can be formed as per Equation (49) below.

$$K = {\sum }_{m , n} {k}_{mn} \qquad ( 49 )$$

In Equation (49), the sum covers a selected subset of all pictures, which could for example be those pairs (m,n) for which the proportion of the area of the pictures overlapping falls within a chosen range.

The intensity modulation function for one picture will be fixed to some predetermined function as a reference point. The intensity modulation functions for the rest of the pictures are selected so as to minimise K. This can be done iteratively by selecting a picture n and minimising the simpler function of Equation (50) below.

$${K}_{n} = {\sum }_{n} {k}_{mn} \qquad ( 50 )$$

Equation (50) measures the intensity mismatch associated with picture n. Iterating this over all n until the solution converges produces a value close to the global optimum. The resulting functions gₙ(●) can then be use to correct the intensity values of pixels used in the compositing process to form the final mosaic.

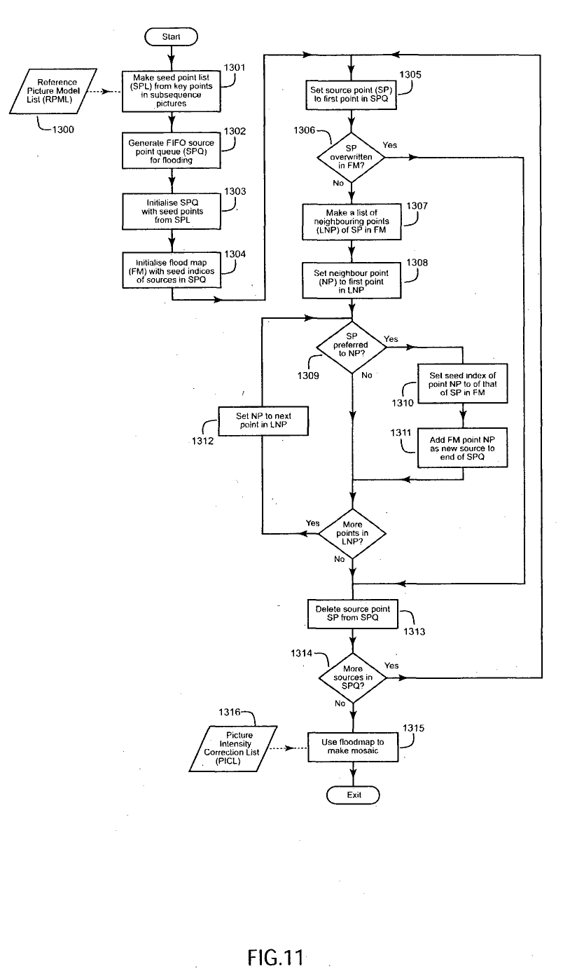

This iterative process is illustrated in one possible embodiment in FIG. 11. The minimum and maximum picture overlap (step 1101) is first set, then one iterates over the pictures in the sequence. For each picture in the sequence, a picture list if formed of all pictures that overlap the picture by more than the minimum and less than the maximum overlap (step 1102). The intensity correction parameters are then set for picture n to minimise Kₙ(step 1103). This process is iterated over all of the pictures until the result converges.

Composition

Once the pictures are accurately registered, there are numerous options for generating a single pixel value from the multiplicity of picture pixels that align with a given location in the mosaic image. A flexible and extensible software architecture is described, which allows a variety of composition rules to be used to generate the final mosaic image. Composition rules are broken down into two types: (i) rules requiring pixel information from the aligned pixels in each picture to decide how much each frame contributes to the pixel value and (ii) rules that do not require such pixel information.

To implement the first of these “compositors”, a system of accumulators is used to accumulate the necessary information from each picture as the pictures are accessed in a serial fashion. This allows one to calculate such things as the component-wise minimum or maximum values for each pixel (with a single three channel accumulator), or the mean pixel value (with one three-channel integer accumulator and one one-channel integer accumulator).

The second class of compositors uses a flooding process to decide which picture should contribute to each of the pixels in the mosaic on the basis of certain characteristics of the seed points chosen from the pictures of the sequence during the registration process. These two broad categories encompass a variety of possible composition rules.

Some existing problems with accumulated alignment errors for approximately linearly panned sequences are limited, by ensuring that the pictures which contribute significantly to any given pixel in the mosaic are separated by only a few pictures in the sequence. This is achieved with a picture weighting function that takes a high value along a thin strip oriented approximately perpendicularly to the dominant motion.

The location of this thin strip within each picture is such that the strip moves from one side of the mosaic to the other in an incremental fashion in the mosaic coordinate system as the picture number is incremented. The resulting pixel in the mosaic is then formed by a weighted average of the pixels from the motion compensated pictures that align with the relevant pixel in the mosaic.

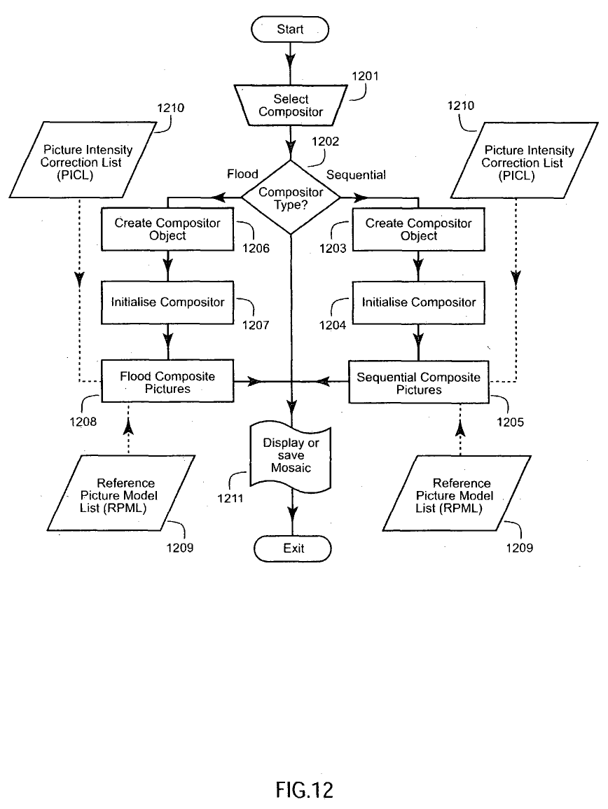

The overall design of the compositing sub-system is represented in FIG. 12. The user first selects which compositor they wish to use (step 1201). Depending on whether the compositor is a sequential compositor or flood compositor (step 1202), the sub-system then instantiates a compositor object, which can provide the required compositing functionality (step 1203 or step 1206) and initialises the compositor object (step 1204 or step 1207). The compositor object then performs the compositing (step 1205 or step 1208) using the Reference Picture Model List (step 1209) to provide the registration data for each picture and the Picture Intensity Correction List (step 1210) to adjust the intensity of the pixels contributing to the mosaic. The resulting mosaic image can then be displayed on screen and if satisfactory, saved to disk (step 1211).

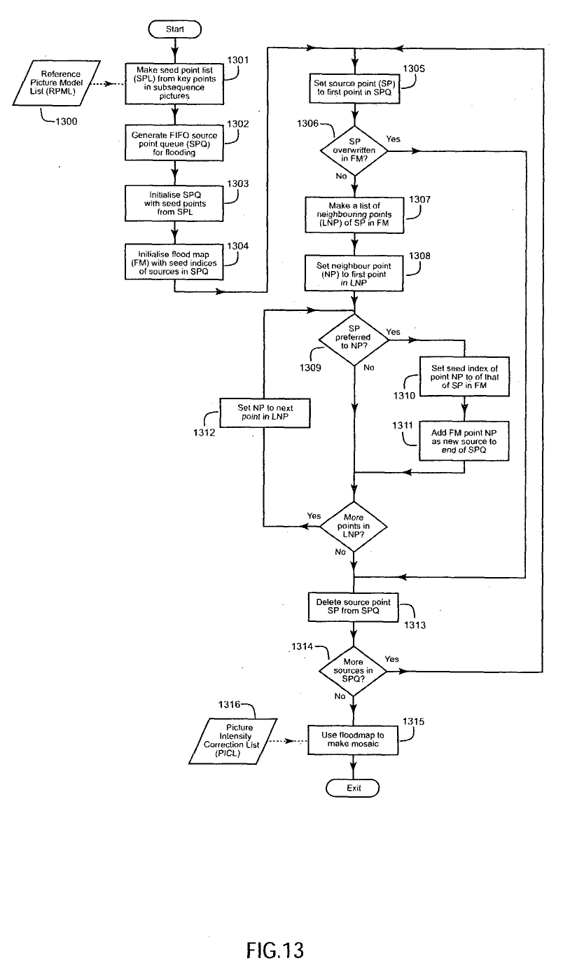

The detailed operation of the flood compositor is illustrated in FIG. 13. The flood compositor sub-system contains seed objects. These seed objects provide different flood compositors with their different functionality. The first thing the flood compositor does is make a list of seed points from selected key points in the pictures of the subsequence to be composited (step 1301). From this list, the flood compositor then makes a First-In First-Out Source Point Queue for the flooding (step 1302). This Source Point Queue is then populated with seed objects generated from the seed points in the Seed Point List (step 1303). A flood map is then generated and initialised with the indices of the initial sources in the Source Point Queue (step 1304).

The iterative flooding process then starts by setting the current Source Point to the first point in the Source Point Queue (step 1305). If this source point has not already been overwritten in the Flood Map (step 1306), then a List of Neighbouring Points of the Source Point in the Flood Map (step 1307) is made and the current Neighbouring point is set to the first point in the List of Neighbouring Points (step 1308).

The seed object associated with the current source point is then used to determine whether the Source Point should be allowed to over-flood the current Neighbouring Point (step 1309). If allowed to over-flood, the seed index of the Neighbouring Point is set in the flood map to the seed index of the source point (step 1310) and the Neighbouring Point is added to the end of the Source Point Queue as a new source point (step 1311). If there are more Neighbouring points, then the Neighbouring Point is set to the next point in the List of Neighbouring Points (step 1312). Once all of the points in the List of Neighbouring Points have been processed, then the current Source Point is deleted from the Source Point Queue (step 1313). If there are more source points in the Source Point Queue (step 1314), then these are processed in the same way. If the Source Point Queue is empty, then the flood-map is used in conjunction with the subsequence pictures and the Picture Intensity Correction List (step 1316) to construct the mosaic image (step 1315).

The flood map indicates, for each pixel in the mosaic which picture should provide the pixel value for that pixel of the mosaic image. So that the generation of the mosaic image can be achieved while accessing the pictures in the subsequence in stored order (that is, the order in which they appear in the compressed file), the construction of the mosaic image also uses a flooding process. At this point the flood map contains a seed index for each point flooded in the previous flood process. Associated with each seed is a picture index that indicates from which picture that seed originates. The flood map is used to generate an Image Flood Seed List (step 1400) by scanning the Flood Map in a predetermined raster order to identify the first occurrence of each seed index (step 1401). This first occurrence is connected to all other occurrences of that seed index in the Flood Map via one or more links to neighbours with the same seed index and so can be used as a seed point to start a flood process to identify the associated region.

A FIFO Primary Source point Queue is created (step 1402) and the Image Flood Seed List is used to fill the Primary Source Point Queue (step 1403). The points on the Primary Source Point Queue are then sorted so that the source points are in the order in which their associated picture appears in the compressed MPEG file (step 1404). For this flood operation the seed point associated with each location in the flood map does not change, but a flag associated with each location is set to indicate if the location has been flooded.

A FIFO Secondary Source Point Queue is then generated (step 1405) for use in the flooding process. The Mosaic Image is initialised to a neutral background colour and the Flood Map “flooded” flags are all reset (step 1406). The next point in the Primary Source Point Queue is then moved to the Secondary Source Point Queue (step 1407) where this point is used to flood the associated region and fill the Mosaic Image points for that region. First, the current Source Point (SP) is set to the first Source Point in the Secondary Source Point Queue (step 1408). Then the flooded flag for the corresponding point in the Flood Map is set to indicate that the point has been flooded and the corresponding pixel in the Mosaic Image is set using pixel information from the picture indicated by the corresponding seed point in the Flood Map (step 1409). This location in the selected picture to be used to generate the required pixel values is determined by the associated motion model for that picture.

Next, a list is created of neighbours of the current Source Point in the flood map that have not yet been flooded (LNP) (step 1410) and the first of these neighbour points are selected (step 1411). If the current Neighbour Point has the same seed index as the current Source Point (step 1412), then the current Neighbour Point is added as a new source point to the end of the Secondary Source Point Queue (step 1413). Once all of the neighbour points on the LNP have been processed in this way (step 1415), the current source point is deleted from the SSPQ (step 1416) and the remaining points are processed on the SSPQ in the same way. Once all points in the SSPQ are processed (step 1417) the next source point in the PSPQ is added to the SSPQ (step 1407). Each point the Primary Source Point Queue is processed in the same way and when all the points on the PSPQ have been processed (step 1418), the Mosaic Image is complete.

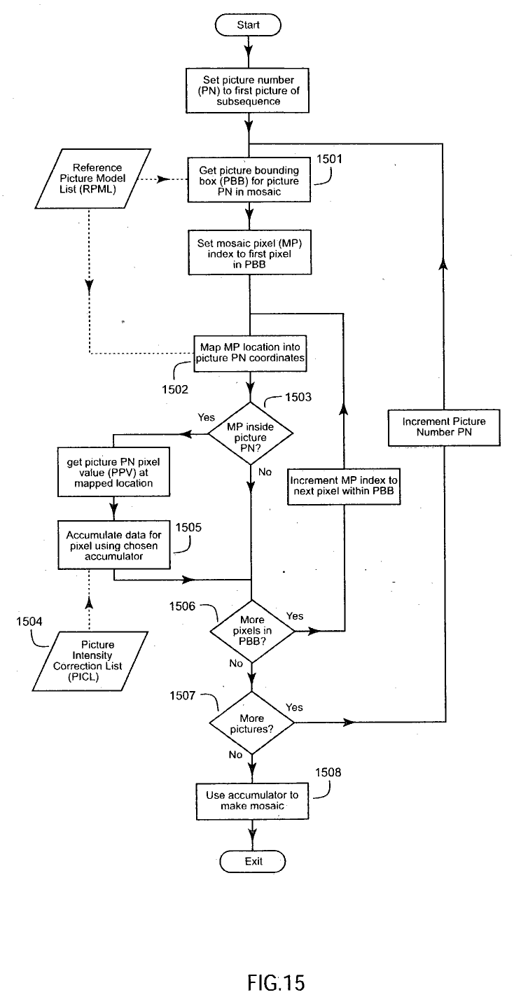

The detailed operation of the sequential compositor is represented in FIG. 15. The sequential compositor contains an accumulator object that provides the desired functionality for the chosen compositor. The pictures of the subsequence are accessed in the order in which these pictures appear in the compressed file. In this way, the pictures can always be decoded from pictures that have already been processed, and only a limited number of pictures need to be retained. For each picture, the Reference Picture Model List is used to calculate the Picture Bounding Box in the mosaic image coordinates (step 1501).

Each pixel of the mosaic within the picture bounding box is then examined and the inverse of the reference picture model for the current picture is used to map the current mosaic pixel back into the coordinate system of the current picture (step 1502). If the current mosiac pixel maps to a point inside the boundary of the current picture (step 1503) then the pixel value of the current picture at the mapped location, corrected using the Picture Intensity Correction model for the current picture from the Picture Intensity Model List (step 1504), is used to modify the values of the accumulators (step 1505). The exact operation on the accumulators depend upon the nature of the accumulators. If, for example, the accumulator is calculating the component-wise maximum then the components values of the pixel of the current picture at the mapped location are compared to the current maximum values. If the determined values are higher than the current values, values the current values are replaced with the determined values.

Each pixel inside the boundary box is processed until all pixels in the boundary box are processed (step 1506), and each picture is processed in this way until all pictures have been processed (step 1507). The accumulator then uses the accumulated information to calculate the mosaic image (step 1508). With a maximum or minimum accumulator, for example, the accumulator directly provides the mosaic image. With the mean accumulator, the accumulator accumulates the total of the contributing pixel component values at each pixel and the number of contributors. The mosaic image is then created by a pixel-wise division of the pixel component values by the number of contributing pictures for that pixel.

Computer Hardware and Software

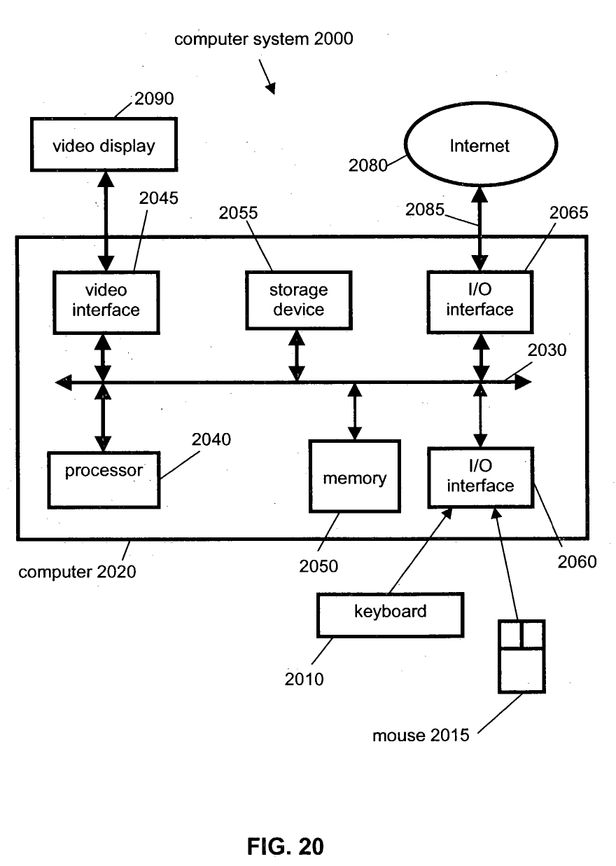

FIG. 20 is a schematic representation of a computer system 2000 that can be used to perform steps in a process that implement the techniques described herein. The computer system 2000 is provided for executing computer software that is programmed to assist in performing the described techniques. This computer software executes under a suitable operating system installed on the computer system 2000.

The computer software involves a set of programmed logic instructions that are able to be interpreted by the computer system 2000 for instructing the computer system 2000 to perform predetermined functions specified by those instructions. The computer software can be an expression recorded in any language, code or notation, comprising a set of instructions intended to cause a compatible information processing system to perform particular functions, either directly or after conversion to another language, code or notation.

The computer software is programmed by a computer program comprising statements in an appropriate computer language. The computer program is processed using a compiler into computer software that has a binary format suitable for execution by the operating system. The computer software is programmed in a manner that involves various software components, or code means, that perform particular steps in the process of the described techniques.

The components of the computer system 2000 include: a computer 2020, input devices 2010, 2015 and video display 2090. The computer 2020 includes: processor 2040, memory module 2050, input/output (I/O) interfaces 2060, 2065, video interface 2045, and storage device 2055.

The processor 2040 is a central processing unit (CPU) that executes the operating system and the computer software executing under the operating system. The memory module 2050 includes random access memory (RAM) and read-only memory (ROM), and is used under direction of the processor 2040.

The video interface 2045 is connected to video display 2090 and provides video signals for display on the video display 2090. User input to operate the computer 2020 is provided from input devices 2010, 2015 consisting of keyboard 2010 and mouse 2015. The storage device 2055 can include a disk drive or any other suitable non-volatile storage medium.

Each of the components of the computer 2020 is connected to a bus 2030 that includes data, address, and control buses, to allow these components to communicate with each other via the bus 2030.

The computer system 2000 can be connected to one or more other similar computers via a input/output (I/O) interface 2065 using a communication channel 2085 to a network 2080, represented as the Internet.

The computer software program may be provided as a computer program product, and recorded on a portable storage medium. In this case, the computer software program is accessed by the computer system 2000 from the storage device 2055. Alternatively, the computer software can be accessed directly from the network 2080 by the computer 2020. In either case, a user can interact with the computer system 2000 using the keyboard 2010 and mouse 2015 to operate the programmed computer software executing on the computer 2020.

The computer system 2000 is described for illustrative purposes: other configurations or types of computer systems can be equally well used to implement the described techniques. The foregoing is only an example of a particular type of computer system suitable for implementing the described techniques.

### CONCLUSION

The techniques described herein relate to constructing mosaic images from a video sequence. These described techniques are primarily for use with compressed MPEG video, and are described hereinafter with reference to this application.

Various alterations and modifications can be made to the arrangements and techniques described herein, as would be apparent to one skilled in the relevant art.

I claim:

1. A method for generating a mosaic image from a video sequence, the method comprising the steps of:
receiving a video sequence, comprising a sequence of pictures, as a coded data stream respectively comprising at least picture information and motion information relating to the video sequence;
selecting a motion model from a number of predetermined motion models which model motion-related differences between the sequence of pictures using motion information rather than picture information from the coded data stream; and
determining, for at least a subset of respective pictures in the sequence, a first estimate of a set of registration parameters relating to the selected motion model, such that the set of registration parameters for at least a subset of the respective pictures can be used to construct a mosaic image from the pictures.

2. The method as claimed in claim 1, further comprising the step of determining, for each respective pair of pictures of at least a subset of the pictures, a set of provisional picture-pair registration parameters, using a subset of the motion information of the coded data stream.

3. The method as claimed in claim 2, further comprising the step of determining, for each respective pair of pictures of at least a subset of the pictures, at least one further set of provisional picture-pair registration parameters, using different subsets of the motion information of the coded data stream.

4. The method as claimed in claim 3, further comprising the step of selecting from the sets of provisional picture-pair registration parameters, for each respective pair of pictures of at least a subset of the pictures, a set of provisional picture-pair registration parameters that is most consistent with at least a subset of the motion information associated with that pair of pictures.

5. The method as claimed in claim 4, further comprising the step of identifying motion information that is not consistent with the selected set of provisional picture-pair registration parameters, so the identified inconsistent motion information can be ignored from further consideration in the step of determining the first estimate of the set of registration parameters.

6. The method as claimed in claim 5, further comprising the step of determining sets of picture-pair registration parameters that relate to registration of the respective pairs of pictures, for each respective pair of pictures for at least a subset of the picture pairs, based upon a selected subset of the motion information.

7. The method as claimed in claim 6, further comprising the step of calculating, for each picture of at least a subset of the pictures, a first estimate of a set of registration parameters, which relates the respective picture to a mosaic coordinate system, based upon the sets of picture-pair registration parameters that relate to at least the respective picture.

8. The method as claimed in claim 5, further comprising the step of selectively decoding selected parts of the coded data stream corresponding with portions of pictures, for use in determining a refined estimate of the picture-pair registration parameters.

9. The method as claimed in claim 8, further comprising the step of determining, for each respective pair of pictures for at least a subset of the picture pairs, a refined estimate of a set of picture-pair registration parameters of selected picture pairs, using at least (i) the corresponding first estimate of the set of registration parameters and (ii) the decoded picture information from selected portions of at least the corresponding pictures.

10 The method as claimed in claim 7, further comprising the step of determining, for at least a subset of the pictures, a consistent set of registration parameters of selected picture pairs, by minimizing a measure of registration inconsistencies between at least a subset of the picture-pair registration parameters and the first estimate of a set of registration parameters of a least a subset of the pictures.

11. The method as claimed in claim 1, further comprising the step of using an intensity-matching procedure to reduce mismatches in intensity between the pictures when constructing the mosaic image.

12. The method as claimed in claim 11, wherein the step of using an intensity-matching procedure uses only the motion information and selected intensity components of the picture information.

13. The method as claimed in claim 1, further comprising the step of constructing a mosaic image from the pictures of the video sequence, using respective sets of registration parameters relating to at least a subset of pictures in the sequence.

14. The method as claimed in claim 13, wherein the mosaic is constructed using the first estimate of registration parameters.

15. The method as claimed in claim 13, wherein the mosaic is constructed using the refined estimate of registration parameters.

16. The method as claimed in claim 12, wherein the mosaic is constructed using the consistent estimate of registration parameters.

17. The method as claimed in claim 12, wherein the mosaic is constructed using the results of an intensity correction procedure to reduce mismatches in intensity between the pictures of the sequence.

18. The method as claimed in claim 1, wherein the motion information is presented in the form of motion vectors relating a block of pixels in one picture to a block of pixels in a second picture of the video sequence.

19. The method as claimed in claim 1, wherein the coded video sequence is coded in a manner compatible with an MPEG standard.

20. Computer software, recorded on a medium, for generating a mosaic image from a video sequence, the computer software comprising:
software code means for receiving a video sequence, comprising a sequence of pictures, as a coded data stream respectively comprising at least picture information and motion information relating to the video sequence;
software code means for selecting a motion model from a number of predetermined motion models that model motion-related differences between the sequence of pictures, using motion information rather than picture information from the coded data stream; and
software code means for determining, for at least a subset of respective pictures in the sequence, a first estimate of a set of registration parameters relating to the selected motion model, such that the set of registration parameters for at least a subset of the respective pictures can be used to construct a mosaic image from the pictures.

21. A computer system for generating a mosaic image from a video sequence, comprising:
means for receiving a video sequence, comprising a sequence of pictures, as a coded data stream respectively comprising at least picture information and motion information relating to the video sequence;
means for selecting a motion model from a number of predetermined motion models that model motion-related differences between the sequence of pictures, using motion information rather than picture information from the coded data stream; and
means for determining, for at least a subset of respective pictures in the sequence, a first estimate of a set of registration parameters relating to the selected motion model, such that the set of registration parameters for at least a subset of the respective pictures can be used to construct a mosaic image from the pictures.
